(19) United States
(12) Patent Application Publication
(10) Pub. No.: US 2013/0310163 A1
(43) Pub. Date: Nov. 21, 2013

(54) GAMING-RELATED USE AND MODIFICATION OF PROFILES

(71) Applicant: WMS GAMING, INC., Waukegan, IL (US)

(72) Inventors: Jesse M. Smith, Chicago, IL (US); Damon E. Gura, Chicago, IL (US); Scott A. Massing, Lincolnwood, IL (US); Danijel Stankovic, Evanston, IL (US)

(73) Assignee: WMS GAMING, INC., Waukegan, IL (US)

(21) Appl. No.: 13/785,944

(22) Filed: Mar. 5, 2013

Related U.S. Application Data
(60) Provisional application No. 61/647,160, filed on May 15, 2012.

(51) Int. Cl. G07F 17/32

(52) U.S. Cl. CPC G07F 17/3241
USPC 463/26; 463/29

(57) ABSTRACT

A wagering game system and its operations are described herein. In some embodiments, the operations can include obtaining gaming information associated with wagering games, wagering game machines, etc. In some embodiments, the gaming information is obtained via a communication link between a gaming device and a mobile device. The operations can further include selecting, loading, and/or accessing a profile for the mobile device in response to obtaining the gaming information. The operations can further include modifying, and/or suggesting modifications for, the profile for the mobile device based on the gaming information. In some embodiments, the operations include modifying a profile for a gaming device or a wagering game based on information obtained from the mobile device.

### RELATED APPLICATIONS

This application claims the priority benefit of U.S. Provisional Application Ser. No. 61/647,160 filed May 15, 2012.

### LIMITED COPYRIGHT WAIVER

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### TECHNICAL FIELD

Embodiments of the inventive subject matter relate generally to wagering game systems and networks that, more particularly related to mobile devices associated with gambling.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

Furthermore, personal mobile devices, such as smartphones, personal digital assistants (PDAs), tablet computers, and so forth, are becoming more popular and more prevalent than ever. Mobile devices continue to advance in technological capabilities. Software application sales for mobile devices are rising. Gaming enthusiasts, like many others, are using mobile devices more often in their personal lives. Therefore wagering game manufacturers, providers, casinos, and the like, are interested in ways to adapt use of mobile devices to the gaming industry.

### BRIEF DESCRIPTION OF THE DRAWING(S)

Embodiments are illustrated in the Figures of the accompanying drawings in which:

FIG. 1 is an illustration of using and modifying profile settings of a mobile device based on gaming information, according to some embodiments;

FIG. 2 is an illustration of using and modifying profile settings of a mobile device and a gaming device, according to some embodiments;

FIG. 3 is a flow diagram 300 illustrating modifying profile settings of a mobile device based on gaming information, according to some embodiments;

FIG. 4 is a flow diagram 400 illustrating modifying profile settings of a gaming device based on information from a mobile device, according to some embodiments;

FIG. 5 is an illustration of a wagering game system architecture 500, according to some embodiments;

FIG. 6 is an illustration of a wagering game computer system 600, according to some embodiments;

FIG. 7 is an illustration of a wagering game machine architecture 700, according to some embodiments; and

FIG. 8 is an illustration of a wagering game system 800, according to some embodiments.

### DESCRIPTION OF ILLUSTRATIVE EMBODIMENTS

This description of the embodiments is divided into five sections. The first section provides an introduction to embodiments. The second section describes example operations performed by some embodiments while the third section describes additional example embodiments. The fourth section describes example operating environments while the fifth section presents some general comments.

### Introduction

This section provides an introduction to some embodiments.

Wagering games are expanding in popularity. Wagering game enthusiasts expect continuous innovations to the wagering game experience. As stated previously, wagering game companies are interested in creating and providing innovative wagering games and gaming features to the demanding public. Further, wagering game manufacturers, providers, etc., are interested in ways to adapt use of mobile devices by the public to the gaming industry.

Some embodiments of the present inventive subject matter include selecting and loading a specific profile for a mobile device for use of the mobile device in a specific gaming situation or environment during a gaming session. Some embodiments include modifying, and/or suggesting modifications for, the profile for the mobile device based on the specific gaming situation or environment. Some embodiments obtain gaming information associated with wagering games or gaming devices, such as via a communication link (either direct or indirect) between a gaming device and a mobile device, and automatically verify whether the specific settings of the profile are optimized for use with the gaming situation or environment based on the gaming information or modify, or suggest modification of, the specific settings of the profile based on the gaming information. Some embodiments include modifying a profile for a gaming device or a wagering game based on information obtained from the mobile device. These embodiments, and other embodiments, are described in further detail below.

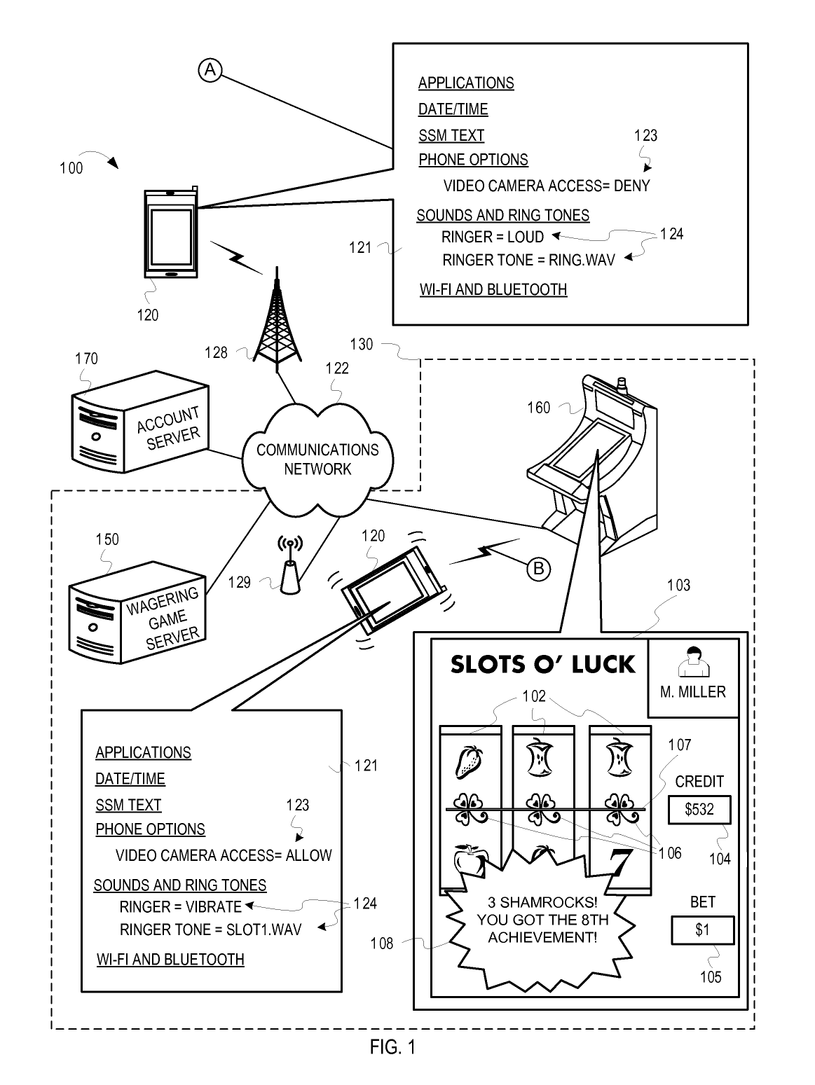

FIG. 1 is a conceptual diagram that illustrates an example of using and modifying profile settings of a mobile device based on gaming information, according to some embodiments. In FIG. 1, a mobile device 120 is connected, via a wireless communications tower 128, to a communications network 122. Also connected to the communications network 122 is an account server 170, a wagering game server 150, a wagering game machine 160, and a wireless transmitter 129. The wagering game machine 160 is included within a gaming venue, such as a casino 130. In some embodiments, the wagering game server 150 and the wireless transmitter 129 are also included in, or at least, connected to, a private network of gaming devices for the casino 130. In some embodiments, one or more of the elements indicated in FIG. 1, (e.g., the mobile device 120, the account server 170, the wireless communications tower 128, the mobile transmitter 129, the wagering game machine 160, the wagering game server 150, and the communications network 122) may be referred to as a wagering game system (“system”) 100. In FIG. 1, various stages (i.e., stages “A” through “B”) represent scenarios or periods during which modifications are made to a profile 121 for the mobile device 120 within the system 100. The profile 121 includes settings related to use of one or more components of the mobile device 120. In some embodiments, the profile 121 indicates one or more settings for one or more of hardware components (e.g., internal hardware, peripherals, electronic and/or mechanical elements, etc.), one or more software components (e.g., core applications, third-party applications, an operating system of the mobile device 120), one or more functions or uses, or any other element of the mobile device 120. The profile 121 can be configurable, or modifiable, such as by manual user input or by automatic processes. Consequently, the profile 121 may also be referred to as a mobile-device profile or a configurable device profile for the mobile device 121. The profile 121 may be stored in a file, in part of a file, in a database, on a disk, or any other storage unit accessible to the mobile device 120. The profile 121 may be stored on the mobile device 120 and/or on other devices to which the mobile device 120 has access, such as the account server 170.

At stage “A,” the profile 121 is configured. In some embodiments, the profile 121 is a configuration file(s) stored on the mobile device 120 that stores settings related to capabilities, functions, or any aspect of the mobile device 120. Some types of settings within the profile 121 can be related to software, hardware, firmware, etc. Some types of settings refer to various applications that have been loaded on the mobile device 120. Other settings refer to information that an operating system for the mobile device 120 uses to control the management of hardware (e.g., speakers, displays, microphones, cameras, etc.) as required by use of applications of the mobile device 120 and other events or communications received by, or sent from, the mobile device 120. The following is an example list of some possible elements of the mobile device 120 that can have settings listed within the profile 121 according to some embodiments: a processor, a memory, a system clock, a display, a network communication element (e.g., transceivers for Wi-Fi, Bluetooth, telephone, etc.), an antenna, a power supply, a camera, a speaker, a gyroscope, a microphone, an input device (e.g., keyboard, touchscreen, etc.), a location device (e.g., global positioning service, or GPS, unit), a biometric device (e.g., a finger-print scanner, a voice-recognition unit, etc.), a touch screen, a mouse, a headphone jack, etc. The following is an example list of some possible types of applications of the mobile device 120 that can have settings listed within the profile 121 according to some embodiments: social media, help, voice activation or recognition, calendar, ringer, email, texting, Internet browser, word processor, graphics editing, games, contacts, maps, weather, authentication, network access, time and date, etc. The above lists are only examples of potential items that could have information stored in the profile 121. Anything related to use of the mobile device 120 can have settings stored in the profile 121.

In one example, during stage “A,” the profile 121 has a first setting that relates to access of a video camera (“camera setting 123”) with a first value that will “deny” outside access to the video camera by one or more third-party applications (e.g., non-core applications) of the mobile device 120 or by external devices to the mobile device 120. In another example, during stage “A,” the profile 121 has a second setting that relates to a volume and sound file associated with a ringer (“ringer settings 124”), with second values that indicated a “loud” ringer volume and a ringer tone stored in a “ring.wav” sound file. In some embodiments, a user modifies the settings of the profile 121 manually, such as while at home, or elsewhere. In some embodiments, the settings of the profile 121 may be set automatically or manually such as during initial configuration of the mobile device 120 during manufacture or during distribution and/or sale of the mobile device 120. In some embodiments, the settings of the profile 121 are set or modified prior to entering the casino 130. In some embodiments, the settings of the profile 121 are set or modified while in the casino 130.

During stage “B,” the mobile device 120 associates with the wagering game machine 160 (e.g., links to, or interfaces with, the wagering game machine 160 to begin authorized inter-communication, such as by linking directly with the wagering game machine 160 or linking indirectly via the wagering game server 150). For example, the mobile device 120 comes within a given distance, or proximity, to a gaming device, such as the wagering game machine 160, which can trigger an association between the mobile device 120 and the wagering game machine 160 where communication between the two begins and authorization is obtained to automatically update the profile 121 on the mobile device 120. The wagering game machine 160 is just one example of a gaming device with which the mobile device 120 can associate. Other examples of gaming devices may include gaming kiosks, electronic game tables, tablet computing devices, the wagering game server 160, the wireless transmitter 129, and any other device associated with gambling that is associated with a gaming venue. When the mobile device 120 associates with the wagering game machine 160, the mobile device 120 and the wagering game machine 160 communicate with each other. The mobile device 120 receives gaming-related information from the wagering game machine 160. For example, the wagering game machine 160 presents wagering game content 103 and communicates gaming-related information (e.g., events, messages, content, outcomes, funds, credit balances, account data, etc.) about the wagering game content 103 or the wagering game machine 160 to the mobile device 120.

The wagering game machine 160 presents the wagering game content 103 during a wagering game session. The wagering game content 103 includes, for instance, slot reels 102, slot symbols 106, one or more paylines 107, a credit meter 104, a bet meter 106, celebratory messages 108, sounds (e.g., sound effects, sound tracks, voices), vibrations, three-dimensional effects, and so forth. The wagering game machine 160 can store the wagering game content 103 and/or the wagering game machine 160 can communicate with the wagering game server 150 to receive and control the wagering game content 103. In some embodiments, the wagering game content 103 can include primary wagering games and secondary wagering games. The primary wagering game, or base game, includes wagering functionality. A secondary wagering game can be related to the primary game, such as a bonus game that is based on activities or accomplishments from the primary wagering game. In some embodiments, the secondary wagering game can be independent of the primary wagering game and can include separate wagers independent of actions or accomplishments of the primary wagering game. The wagering game content 103 is just one type of content that can be presented via the wagering game machine 160. The wagering game machine 160 can present non-wagering game content, such as casino services, advertisements, help applications, personal concierge services, email, social communication services (e.g., chat, email, etc.), and so forth. Therefore, because the wagering game machine 160 can present wagering game content 103 and non-wagering game content, the wagering game machine 160 can communicate all types of information to the mobile device 120. For brevity, however, any information that originates from the wagering game machine 160, or from any other gaming device associated with gambling, will be referred to generally as gaming-related information or gaming information.

In response to obtaining the gaming-related information, the mobile device 120 can access the profile 121 and suggest modifications for, and/or make modifications to, the profile 121 based on the gaming-related information. For example, a gaming outcome from the wagering game content 103 (e.g., the celebratory message 108 appears in response to a winning wagering game outcome), can trigger a response from the mobile device 120, such as causing a video camera on the mobile device 120 to turn on and record information about the gaming outcome for subsequent playback. However, the camera setting 123 for the mobile device 120 indicates that third party applications or communications should be denied access to the video camera. However, because the mobile device 120 is engaged in authorized communication with the wagering game machine 160 (e.g., the mobile device 120 is within a proximity to the wagering game machine 160, and an authentication process that verifies that the wagering game player (e.g., the user “M. Miller” has been performed to permit the profile 121 to be modified), then the camera setting 123 is modified to allow access to the video camera of the mobile device 120. In some embodiments, the mobile device 120 first presents a suggestion for the modification, which a player can authorize via user-input (e.g., an application on the mobile device 120 presents a notification message that suggests the modification and requests the player to accept or deny the suggested modification, such as by pressing a button on a graphical user interface of the mobile device 120, shaking the mobile device 120, or in response to some other user input that indicates either an affirmative or negative authorization for the modification). In some embodiments described herein, where a modification is said to be made to a profile, the modification can be preceded by an authorization, such as by first suggesting the modification and requiring a direct, or manual, user response, or by accessing a setting that was set by the player that grants automatic modifications to be made. Likewise, the ringer settings 124 can be modified so that the ringer setting can be changed from a value of “loud” to a value of “vibrate” and so that the ringer tone can be changed from a value of “ringer1.wav” to a value of “slot1.way.” The settings 121 can also be modified to allow the wagering game machine 160 access to a storage unit (e.g., a memory card installed within the mobile device 120) to which the wagering game machine 160 can transmit and store a file (e.g., the “slot1.wav” ring tone file).

After the system 100 modifies the profile 121 on the mobile device 120, the mobile device 120 stores a version of the profile 121 on the mobile device 120 for subsequent use. For example, after the mobile device 120 terminates a gambling session, the mobile device 120 may return the settings of the profile 121 to their original settings and/or load an original version of the profile 121 for non-gaming purposes. Therefore, the mobile device 120 can have multiple versions of the profile 121, such as one for gaming and one for non-gaming. During a subsequent gaming session, the system 100 loads the version of the profile 121 into the mobile device 120 that is related to gaming.

The mobile device 120 can have multiple profiles related to gaming. For instance, one profile may be related specifically to a certain wagering game or gaming device, whereas a different profile is related to a different wagering game or different gaming device based on the characteristics of the wagering games and/or gaming devices. Each profile can be configured for use specifically with the particular wagering game and/or gaming device. The system 100 can select one of the profiles to load into the mobile device 120 for a wagering game session based on specific information related to the wagering games or gaming devices (e.g., based on unique identifiers for the wagering games or gaming devices, based on a history of use of the wagering game or gaming device, etc.) In some embodiments, the system 100 selects and loads a specific version of the profile 121 based on specific conditions or information that are not directly related to the wagering game or the gaming device, such as a time or date (e.g., load a specific one of the profiles when playing evenings or weekends, load a specific profile when on vacation, etc.), a location (e.g., load a specific one of the profiles based on a specific casino where a player is located, load a specific profile based on the player being within a specific location within a casino, etc.), or other conditions (e.g., load a specific profile when the player account balance has dropped below a specific level, load a specific profile when the player has wagered over a certain amount, load a specific profile, load a specific profile based on levels of achievements that the player has obtained for a persistent wagering game, etc.).

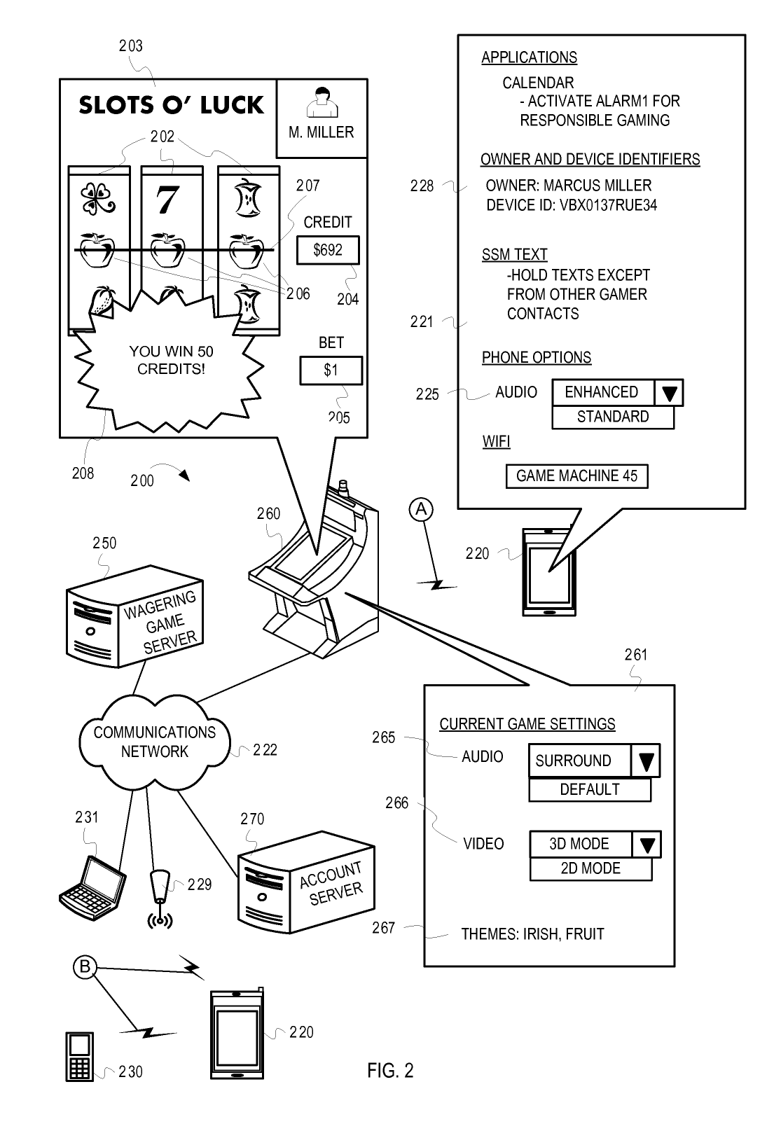

The above examples are but some of the many ways that wagering devices and mobile devices can select, load, use and/or modify profiles. Other examples are described in connection with FIG. 2 and other Figures herein.

Further, some embodiments of the inventive subject matter describe examples of using and modifying profiles in a network wagering venue (e.g., an online casino, a wagering game website, a wagering network, etc.) using a communication network, such as the communications network 122 in FIG. 1. For example, in some embodiments, profiles can be stored on the account server 170 or wagering game server 150 and be modified based on information communicated between a mobile device 120 and a gaming device. Embodiments can be presented over any type of communications network that provides access to wagering games, such as a public network (e.g., a public wide-area-network, such as the Internet), a private network (e.g., a private local-area-network gaming network), a file sharing network, a social network, etc., or any combination of networks. Multiple users can be connected to the networks via computing devices. The multiple users can have accounts that subscribe to specific services, such as account-based wagering systems (e.g., account-based wagering game websites, account-based casino networks, etc.).

Further, in some embodiments herein a user may be referred to as a player (i.e., of wagering games), and a player may be referred to interchangeably as a player account. Account-based wagering systems utilize player accounts when transacting and performing activities, at the computer level, that are initiated by players. Therefore, a “player account” represents the player at a computerized level. The player account can perform actions via computerized instructions. For example, in some embodiments, a player account may be referred to as performing an action, controlling an item, communicating information, etc. Although a player, or person, may be activating a game control or device to perform the action, control the item, communicate the information, etc., the player account, at the computer level, can be associated with the player, and therefore any actions associated with the player can also be associated with the player account. Therefore, for brevity, to avoid having to describe the interconnection between player and player account in every instance, a “player account” may be referred to herein in either context. Further, in some embodiments herein, the word “gaming” is used interchangeably with “gambling.”

Although FIG. 1 describes some embodiments, the following sections describe many other features and embodiments.

Modifying Profile Settings of a Mobile Device and a Gaming Machine

FIG. 2 is a conceptual diagram that illustrates an example of using and modifying profile settings of a mobile device and a gaming device, according to some embodiments. In FIG. 2, a mobile device 220 communicates with a wagering game machine 260. The wagering game machine 260 is connected to a communications network 222. Also connected to the communications network 222 is an account server 270 and a wireless transmitter 229. The mobile device 220 can connect to the communications network 222 via one or more wireless transmitters 229, such as to communicate with the wagering game machine 260, the account server 270, and one or more other devices, such as a personal computer or laptop 231. In some embodiments, the wagering game machine 260 is included within a gaming venue, such as a casino. In some embodiments, a wagering game server 250 and the one or more wireless transmitters 229 are also included in, or at least, connected to, a private network of gaming devices for a gaming venue. In some embodiments, one or more of the elements indicated in FIG. 2, (e.g., the mobile device 220, the account server 270, the one or more wireless transmitters 229, the wagering game machine 260, the wagering game server 250, and the communications network 222) may be referred to as a wagering game system (“system”) 200. The system 200 is similar, in many respects, to the system 100 of FIG. 1.

In FIG. 2, various stages (i.e., stages “A” through “B”) represent scenarios or periods of use (e.g., selection and loading) or modification of a profile 221 for the mobile device 220 within the system 200 and/or to a profile 261 for the wagering game machine 260. For example, in some embodiments, the wagering game machine 260 communicates gaming-related information, and, based on the gaming-related information, profile 221 is selected and/or modified. In some embodiments, the gaming-related information may include data associated with the profile 261 related to a use for the wagering game machine 260, a wagering game server, or some other gaming-related device or application. The profile 261 can be related to a specific game or type of game presented via the wagering game machine 260. In some embodiments, the mobile device 220 communicates mobile-device-related information to the wagering game machine 260 which is used to update the profile 261 associated with the wagering game machine 260 (e.g., automatic modification of the profile 261 by the wagering game machine 260 or by a wagering game server based on the mobile-device-related information). In some examples, the mobile-device-information includes information related to capabilities, functions, or any aspect of the mobile device 220 or a user of the mobile device 220 (e.g., events, messages, content, setting values, software information, system information, control information, user information, etc.). The information can include descriptions and values of settings within the profile 221. In some embodiments, the mobile-device-related information may be referred to as profile information or profile data.

At stage “A,” the mobile device 220 and the wagering game machine 260 associate with each other and communicate information to each other as previously described. For instance, the wagering game machine 260 communicates gaming-related information to the mobile device 220, which is used to select and/or modify settings for the profile 221 based on the gaming-related information (e.g., the system automatically select and loads the profile 221 when the mobile device 220 initiates communication with the wagering game machine 260, the mobile device 220 automatically modifies the profile 221 based on the gaming-related information when the mobile device 220 is associated with the wagering game machine 260, etc.). In some examples, the wagering game machine 260 sends requests for the loading and/or modification (e.g., the mobile device 220 receives instructions from the wagering game machine 260 to select, load, access, read from, and/or write to, the profile 221). In some embodiments, the mobile device 220 receives the request from the wagering game machine 260 and presents a message to a user to select and/or update the profile 221 in response to the request. In other embodiments, the mobile device 220 receives the request from the wagering game machine 260 and the mobile device 220 automatically selects and/or updates the profile 221 in response to the request without user intervention. In some embodiments, the mobile device 220 authorizes the wagering game machine 260 to automatically select and/or modify the profile 221 of the mobile device 220. In some embodiments, the mobile device 220 uses an application to communicate with gaming devices, select and load profiles, make suggestions for modifications of profiles, and modify profiles. The application can be launched or opened, manually or automatically based on user settings for the application, when the mobile device 220 enters a casino, approaches a gaming device, etc.

In some examples, the profile 261 relates to settings of a current wagering game that is being played via the wagering game machine 260. The settings of the profile 261 may include a setting 265 related to audio presentation for wagering game content 203. For example, the wagering game content 203 (e.g., for a fictitious wagering game “Slots O'Luck”) presents slots reels 202 with slot symbols 206 that can present game results (e.g., a winning result may include a payline 207 graphic to indicate when a win occurs according to game rules). The wagering game content 203 also presents a credit meter 204, a bet meter 205, and one or more messages associated with the wagering game, such as a celebratory message 208. The wagering game machine 260 also includes speakers to present audio content for a sound track and other audio effects associated with the wagering game content 203. The wagering game machine 260 may include different capabilities for sound quality, such as a default setting that presents sound with stereo-sound, and an enhanced setting that presents sound with multi-channel surround sound. In some embodiments, the wagering game machine 260 scans the profile 221 and detects that the mobile device 220 has a setting 225 with options for different sound playback quality, and is originally set to a “standard” setting value, which is not an “enhanced” audio quality setting value. The wagering game machine 260 determines that the profile 261 indicates that the setting 265 is set to “surround” sound, which is an enhanced audio setting. As a result, the wagering game machine 260 and/or the wagering game presented via the wagering game machine 260, requests the mobile device 220 to update the setting 225 to be “enhanced” audio. Therefore, during a wagering game session, the wagering game machine 260 and/or the wagering game presented via the wagering game machine 260, can utilize the mobile device 220 to present some audio effects using an enhanced audio quality. The wagering game machine 260 and/or the wagering game presented via the wagering game machine 260, can further request modification of, or directly modify, other settings in the profile 221 based on the setting 265, such as display settings, volume settings, vibration settings, and so forth. It should also be understood that the mobile device 220 can detect profile data from the profile 261 and modify the profile 221 in response to detecting the profile data from the profile 261 instead of, or in addition to, the wagering game machine 260 detecting profile data from the profile 221 and requesting modification of, or modifying, the profile 221.

The profile 261 includes other settings. For example the profile 261 includes a setting 266 for the wagering game that indicates a three-dimensional (3D) presentation mode (e.g., for presentation of binocular, stereoscopic and/or autostereoscopic content) and a two-dimensional (2D) presentation mode. The wagering game machine 260 can scan the profile 221 and detect capabilities of the mobile device 220 for presentation in 2D or 3D and, in response, suggest or request modifications to the settings for, or directly modify settings for, the profile 221 and/or modify or verify settings of the profile 261 related to 3D or 2D presentation. In some embodiments, if the mobile device 220 does not have a 3D display, the wagering game machine 260 may request other changes related to visual presentation of content via the mobile device 220, such as requesting a modification to a screen resolution setting of the mobile device 220.

In another example, the profile 261 includes a setting 267 related to a game theme. Based on the game theme, the profile 221 can change. For example, for a wagering game theme that is based on an action movie, the profile 221 is modified to enable and grant permissions for access to media rich features and applications of the mobile device 220 that can present media rich content associated with the wagering game. On the other hand, if the wagering game theme is a nature based theme, then the profile 221 is modified to affect colors, background graphics, and audio tones of the mobile device 220 to match that of the wagering game.

Furthermore, as mentioned previously, in some examples, the mobile device 220 communicates mobile-device-related information to the wagering game machine 260 which is used to update the profile 261 associated with the wagering game machine 260. For instance, the mobile device 220 communicates to the wagering game machine 260 the information about the setting 225 (e.g., information that the mobile device 220 has more than one sound quality setting and that the current value for the setting 225 is set to the “enhanced” audio quality value). As a result, the wagering game machine 260 can adjust its setting 265 to a corresponding value (e.g., if the setting 265 was set to a “default” setting value, then the wagering game machine 260 can change the setting to an enhanced audio, or “surround” sound, setting value).

In some embodiments, the profile 261 is changed based on features or functionality of the mobile device 220. If the mobile device 220 does not have certain features, then the profile 261 changes based on the type of features of the mobile device 220. The wagering game machine 260 would then present a different gaming experience than if the mobile device 220 did have certain features.

In some embodiments, the wagering game machine 260 does not modify its profile settings 261, but verifies that its settings correspond to existing settings within the profile 221. For instance, the wagering game machine 260 detects that the setting 225 indicates enhanced audio quality, and detects that its setting 265 is correspondingly set to an enhanced audio quality value, and, therefore, does not make a change to the setting 265, but verifies that the settings are consistent or compatible.

The examples described in FIG. 2 are only some of the countless examples of modifying the profile 221 based on gaming-related information and/or modifying the profile 261 based on mobile-device-related information.

### Example Operations

This section describes operations associated with some embodiments. In the discussion below, some flow diagrams are described with reference to block diagrams presented herein. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform more or less than all the operations shown in any flow diagram.

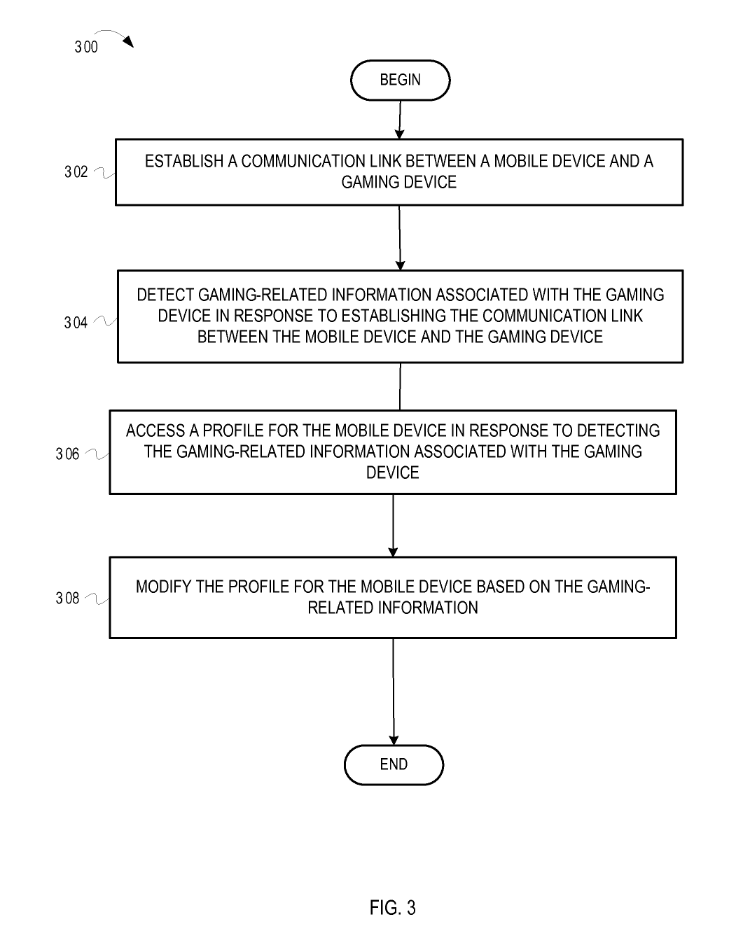

FIG. 3 is a flow diagram (“flow”) 300 illustrating modifying profile settings of a mobile device based on gaming information, according to some embodiments. In FIG. 3, the flow 300 begins at processing block 302, where a wagering game system (“system”) establishes a communication link between a mobile device and a gaming device. In some embodiments, the system detects that the mobile device is within a proximity to a portion of the wagering game machine and establishes a communication link, to initiate the communication session, between the mobile device and the wagering game machine in response to the mobile device being within the proximity to the portion of the wagering game machine. For instance, the system can determine that the mobile device is within a given distance to a given sensor of the wagering game machine (e.g., determine that the mobile device is within wireless communications range of the wagering game machine, determine that the mobile device is within five feet of the wagering game machine, etc.) or specifically oriented in relation to a certain part of the wagering game machine (e.g. determine that the mobile device is inserted into, or placed upon, a docking port of the wagering game machine, determine that the mobile device is in front of or touching a part of the wagering game machine, etc.). Based on the mobile device being within the distance to the portion of the wagering game machine, the system establishes a secure communication session between the mobile device and the wagering game machine. In other embodiments, the mobile device and wagering game machine establish a communication link indirectly, such as via an intermediate server (e.g., a wagering game server). In that example, the mobile device communicates with the intermediate server and the intermediate server conveys communications to the wagering game machine or wagering game presented via the wagering game machine. In some embodiments, where the wagering game is controlled primarily by the server, the mobile device communicates with the server, which provides information to a game processed by the server. In some embodiments, the mobile device and server communicate via a communications link, but the server does not transmit information to the wagering game machine pertaining to the mobile device. In that example, the server may communicate other gaming information to the wagering game machine, such as gaming content, gaming outcomes, wagering data, etc., however communications between the mobile device and the server are limited to each other.

In some embodiments, the system authorizes the communication between the mobile device and the gaming device (e.g., verifies that a player to whom the mobile device belongs authorizes communication between the mobile device and a wagering game machine and/or wagering game server). For instance, in FIG. 2, the profile 221 includes settings 228 that indicate an owner (e.g., Marcus Miller) of the mobile device 220. The settings 228 can also include a unique identifier associated with the player and/or the mobile device 220. For instance, the account server 270 includes a unique identifier that identifies the player (e.g., an account identifier) and/or the mobile device 220. Furthermore, the player logs in to the wagering game machine 260 using a unique identifier, such as a wagering game player account identifier. In some embodiments, the account server 270 links together the unique identifier obtained from the mobile device 220 (e.g., a serial number of the mobile device 220 or account identifier associated with the player and/or mobile device 220), or a unique identifier communicated via the mobile device 220 (e.g., a unique identifier communicated via an application run on the mobile device 220), with a unique identifier associated with the player that the player uses to initiate a wagering game session via the wagering game machine 260. In some embodiments, the unique identifiers are different. For instance, where a serial number for the mobile device 220 is associated with a wagering game player account identifier. In some embodiments, however, the unique identifiers are the same. For instance, a player can log in to a non-gaming session via an application on the mobile device 220 using a wagering game player account. When the player logs in to the wagering game machine 260 using the same wagering game player account, then the system 200 determines that the mobile device 220 and the wagering game machine 260 are associated with the same user, and thus determines that the wagering game machine 260 is authorized to communicate with the mobile device 220 and vice versa.

In some embodiments, the system 200 authorizes a communication link between the mobile device 220 and the wagering game machine 260 by presenting an authorization message on the display of the mobile device 220 and/or the wagering game machine 260 to link the two devices. The player can authorize the link by acknowledging the authorization message (e.g., the mobile device 220 presents a message that says, “Do you authorize a communications link with this wagering game machine?” with a button that the player can press to acknowledge and authorize the communications link). The system 200 can impose other restrictions to assure proper authorization. For example, in some embodiments, the communication link is authorized only if the mobile device 220 is close enough to docking station (e.g., touching a docking station) on the wagering game machine 260. In some embodiments, the mobile device 220 may need to be registered as belonging to a player or gaming account prior to initiating a communication session with the wagering game machine 260. In some embodiments, the communication link is authenticated via near-field communication (NFC), biometric, or other methods. In some embodiments, to authenticate, the mobile device 220 may need to be swiped close to a sensor on the wagering game machine 260. In other embodiments, the profile 221 may include, or offer, different options for authentication.

Returning to FIG. 3, the flow 300 continues at processing block 304, where the system detects gaming-related information associated with the gaming device in response to establishing the communication link between the mobile device and the gaming device. For example, as described in FIGS. 1 and 2 the gaming-related information can relate to events, messages, content, outcomes, funds, credit balances, account data, profiles, or any other kind of information about wagering game content presented via a wagering game machine, wagering game applications run via a processor of a wagering game machine or wagering game server, settings or configurations of a wagering game machine, game-related data stored on memory devices of the wagering game machine and/or server, instructions processed by the wagering game machine and/or server, and so forth. In some embodiments, other gaming devices, such as a kiosk, an electronic gaming table, etc. communicate gaming-related data to the mobile device in addition to, or instead of, a wagering game machine.

The flow 300 continues at processing block 306, where the system accesses a profile for the mobile device in response to detecting the gaming-related information associated with the gaming device. Some examples of information that can be stored in a profile were described above in associated with FIG. 1. The following list includes some examples of types of functionality or capabilities of a mobile device that can be affected via modification of the profile.

Clock.

In some embodiments, the system turns on a clock application on the mobile device to track an amount of time for gambling via the wagering game machine.

Ringer.

In some embodiments, the system turns a ringer on or off or changes a volume for the ringer.

Display.

In some embodiments, the system modifies settings associated with a touch screen, a 3D display, or other types of displays of a mobile device.

Operating System.

In some embodiments, the system communicates with an operating system of the mobile device to access and/or generate user data, control data, or other types of data associated with the mobile device.

Network Communications.

In some embodiments, the system turns on or shuts off network access (e.g., shut of radio antenna, Bluetooth, Wi-Fi, power, etc.). In some embodiments, the system adjusts to specific Wi-Fi settings for a casino (e.g., activates property encryption, password, etc.).

Calendar.

In some embodiments, the system accesses a calendar application to set events related to gaming, such as group events, tournaments, etc. In some embodiments, the system accesses a calendar on the mobile device to set an alarm for responsible gaming to warn a player that they have been gambling for more than a given period.

Camera.

In some embodiments, the system turns on the camera or video camera of the mobile device. For example, the system triggers a video camera to record when a player enters a bonus round. In some embodiments, the camera on the mobile device tracks the player's position or actions (e.g., detects when a player has selected a 3D object in 3D space). In some embodiments, the camera on the mobile device turns on when player puts the mobile device in a docking station of the wagering game machine.

Speakers.

In some embodiments, the system turns on speakers of the mobile device to play game content. In some embodiments, the system speaks a direct verbal command directed to the player via the speakers, such as when the mobile device is in the player's pocket.

Gyroscope.

In some embodiments, the system causes the mobile device to vibrate to indicate that a player has interacted with a 3D location in 3D space.

Microphone.

In some embodiments, the system synchronizes with audio content of the wagering game machine. For example, in some embodiments, a microphone on the mobile device detects play of a soundtrack from the wagering game machine. Based on musical clues recorded by the microphone, the system synchronizes the timing of presentation of audio content on the mobile device to a timing of presentation of the game soundtrack via the wagering game machine.

Help Application.

In some embodiments, a help file is presented on the mobile device based, contextually, with a degree of progress for a player in a wagering game. The help file can be presented on the mobile device so that the player does not have to go out of the game on the wagering game machine to access a help file. Instead, however, the player can access the help file via the mobile device.

Input Devices/Peripherals.

In some embodiments, the system detects swiping motions of the mobile device. In some embodiments, the system receives text typed into the mobile device as input to a wagering game presented via the wagering game machine.

Voice Activation/Voice Recognition.

In some embodiment, a personal assistant (e.g., Siri on iPhone mobile devices by Apple Inc.) activates on the mobile device based on information of the wagering game.

Social Media.

In some embodiments, the system exposes friends on social media applications who have indicated gambling as an interest or hobby. The system can detect which games may be gambling at the time. The system can show friends who are in a casino or in the gaming venue the location of the mobile device.

GPS.

In some embodiments, the system performs geo-fencing on the mobile device, such as to detect when a player or mobile device is within a casino, to detect a distance from a wagering game machine, and so forth.

The flow 300 continues at processing block 308, where the system modifies the profile for the mobile device based on the gaming-related information. In some examples, the mobile device can communicate with the wagering game via a common interface. In some embodiments, the wagering game can hook into the mobile devices operating system (OS). A wagering game machine can communicate a request to the OS of the mobile device to modify the profile. The OS receives the request and handles the request. For example, the OS grants permission to modify the profile. The OS can check application settings, open applications, changes application settings and/or transfer requests to applications. In some embodiments described herein, where a modification is said to be made to a profile, the modification can be preceded by an authorization, such as by first suggesting the modification and requiring a direct, or manual, user response, or by accessing a setting that was set by the player that grants automatic modifications to be made. In some embodiments, the mobile device uses an application to communicate with gaming devices, select and load profiles, make suggestions for modifications of profiles, and modify profiles. The application can be launched or opened, manually or automatically, based on user settings for the application, when the mobile device enters a casino, approaches a gaming device, etc. In some embodiments, prior to making modifications, the system presents a notification message, via a user interface of the application, which notification message indicates a suggestion for one or more modifications to the profile. The player can manually specify which of the modifications should be made (e.g., the user interface presents a listing of the proposed modifications with an option for a player to accept or reject all, none, or any individual ones of the proposed modifications).

In some embodiments, the system modifies, and/or suggests modifications for, a profile based on specific wagering-game conditions. In one instance, the profile includes user preferences for different settings associated with the mobile device. The profile automatically loads or changes applications on the mobile device based on information obtained from the wagering game, wagering game machine, or gaming venue. For example, the system can search through settings within the profile for any indication whether or not a player has a preference regarding being disturbed. The system can disable community gaming type features of the game or may only allow certain players/friends to bother the player, using specific features of the phone (e.g., telephone calls, emails, texts, social media applications, etc.), while the player is playing certain games. For example, the profile can be modified to indicate that only other friends who like a specific game will be contacted, or will allow conversations to be made to the player, while the player is playing that specific game.

In another instance, the system can suggest modifications and/or modify a profile to have settings that can change on the mobile device based on specific games or specific gaming conditions. In some embodiments, the system compares information regarding one or more settings of the profile for the mobile device to at least one characteristic of the wagering game or the wagering game machine indicated within the gaming-related information. The system can modify the one or more settings of the profile based on, or in response to, the comparing. For instance, the system modifies a profile for a mobile device based on functionality, game modes, gaming events, or other characteristics of the wagering game or wagering game machine. For example, the system obtains gaming-related information and device-related information (e.g., searches through profiles, scans event logs, receives event broadcasts, etc.), and compares the information from the mobile device and from the wagering game machine against each other (e.g., compares gaming-related information to device-related information, and vice versa), to determine if there are any compatibilities or incompatibilities between characteristics of the devices (e.g., to determine whether the mobile device can accommodate a specific gaming mode based on the functionality of the mobile device). The system can update settings of the profile for the mobile device (or for the wagering game or wagering game machine), based on the determination of whether the functionality of the mobile device is compatible with the characteristics (e.g., the functionality) of the wagering game and/or wagering game machine (or vice versa). For example, in FIG. 2, the system 200 detects setting 266 (e.g., determines whether the setting is set to the value of 3D or 2D for the wagering game), and, based on the value of setting 266, the system 200 modifies settings within the profile 221 for the mobile device 220 accordingly (e.g., modifies display settings for the mobile device 220, modifies sound settings for the mobile device 220, etc.).

Returning to FIG. 3, in some embodiments, the profile can be updated based on the player's habits or history of how certain games were played in the past or how settings were modified on a gaming device. The system can store the player's past history as preferences within a profile associated with the player, a player account, a wagering game, a wagering game machine, a mobile device, etc. In one example, if a player turns volume up on a wagering game machine whenever the player plays a specific type of game (e.g., for a specific wagering game title, theme, or category) or for a specific condition (e.g., after a certain time of day, when background noise is above a specific decibel level, when a bonus game appears, when the player has recently obtained a game achievement), then the system can automatically modify the profile settings of the mobile device to the player behavior and turn up a volume for a ringer of the mobile device. In another example, if the player indicates in a wagering game to not show a fish character or the player tends to turn volume down for a specific wagering game, then, when the player initiates a wagering game session, the system can modify, or verify, the profile settings for the mobile device to ensure that they comply with the player's history of not showing the fish character or turning down the volume. For instance, if the player tends to not show, or consistently hides, the fish character during previous wagering game sessions, the system may infer from the hiding of the fish character that the player does not like disruptions while gambling, and, consequently, the system changes a profile on the mobile device to ensure that the mobile device does not interrupt the player while gambling (e.g., modifies the profile on the mobile device to turn off a ringer, turn down volume settings on the mobile device, modify email or text-message notification settings to be minimal or silent, etc.).

The system can also detect a history of use of the mobile device while gambling or while playing a specific wagering game (e.g., the player consistently turns off the ringer of the mobile device before gambling sessions or before playing a specific game). In response, the next time that the same condition occurs (e.g., the player is gambling or the player is playing the specific game), the system updates the mobile device profile to automatically do what the player had previously done (e.g., turn off the ringer).

In some embodiments, the system can also update a profile for the wagering game or the wagering game machine based on history of gaming or use of the mobile device. For example, the system stores a record of the player's use of the mobile device, such as that a player consistently turns off, or turns down, the ringer of the mobile device before gambling sessions or before playing a specific game. Consequently, the next time that the player initiates a wagering game session or begins play for a specific wagering game, the system can read the stored history, analyze the history, and determine that the player does not want to be distracted by non-gaming activity, such as specific advertising and marketing messages or non-emergency announcements that may appear via the wagering game machine during the wagering game session. Thus, the system modifies a profile associated with a specific wagering game or wagering game machine to correspond with a preference for limited disruptions.

In some embodiments, the system modifies and/or suggests modifications to a profile for a mobile device to continue presenting content in response to a malfunction of a wagering game machine. For example, if during a gaming session a wagering game machine loses some degree of functionality (e.g., a speaker, a button panel, etc.), instead of the wagering game machine closing the wagering game application or terminating the gaming session, until a technician can fix the wagering game machine, the mobile device's profile updates automatically to continue presenting content on the mobile device so that the player can continue playing.

In some embodiments, the system modifies, and/or suggests modifications to, a profile based on game-specific profiles. For example, every wagering game, or type of wagering game, presented via a wagering game machine can have a specific profile. Specific games can have specific settings related to specific game rules, game content, game themes, etc. For instance, the system can modify a profile for a mobile device to modify a ring tone on the mobile device to match a sound or song specific to the wagering game. Based on the concept or theme of the wagering game, the game-specific profile can indicate different settings or features to enable or disable on the mobile device (e.g., a movie based theme for a game may affect media rich features of phone, a nature based theme may affect colors and audio tones of phone, etc.).

In some embodiments, the system modifies, and/or suggests modifications to, a profile of the mobile device so that certain features of mobile device are modified or used based on where the mobile device is located (e.g., when the mobile device is in a docking station on the wagering game machine, when mobile device is in a player's pocket, etc.). For instance, the system modifies, or suggests modifications, to a profile on a mobile device based on:

(1) a location of the mobile device in relation to the player (e.g., if the mobile device is in the player's pocket as opposed to in a player's hand, the system modifies settings to make more use of the gyroscope to vibrate during gaming events);

(2) a location of a player's mobile device in relation to a wagering game machine (e.g., if the mobile device is in a docking station certain features may be available based on the profile settings for the mobile device such utilization of text messaging features or visual elements of the mobile device, if the mobile device is moving away from, or toward, the wagering game machine, the system automatically notifies the player via the mobile device (e.g., via vibration), logs in/logs out, a player from a gaming session using a feature or application of the mobile device, locks out an e-wallet functionality, etc.);

(3) a location of the player's mobile device in relation to another person's mobile device (e.g., if another person's mobile device is close to the player's mobile device for purposes of a group game);

(4) a location of another player's mobile device in relation to the wagering game machine of the player to whom the first mobile device belongs (e.g., if the other person's mobile device is too close to the wagering game machine the system assumes snooping by the other person and modifies presentation of content in a way that uses the mobile device of the player or excludes broadcasting of certain types of data); or

(5) some combination of the above.

In some embodiments, the system can activate features that the mobile device may not have based on gaming conditions. For example, a player may not have 4G network capabilities on a mobile device, but because the player plays a specific wagering game or makes wagers of a certain level for a wagering game, the game provider subsidizes 4G network capabilities on the mobile device for a certain period of time. For instance, the system can increase higher bandwidth between a mobile device and a cell phone tower and modify the profile for the mobile device to have proper settings to enable the higher bandwidth. In another instance, the system can cause the mobile device to run at a higher processing cycle by modifying a portion of the profile related to processing cycle capabilities. Sometimes the profile is hidden to a player's view. For example, a setting related to processing cycles may be in a profile (e.g., a system file) associated with an OS of the mobile device which a user account of the mobile device may not have permissions to access directly, view or modify without special administrative level rights.

In some embodiments, the system modifies, and/or suggests modification of, a profile on a mobile device based on a number of other players around the mobile device. For instance, the system can detect a number of other player's mobile devices in the vicinity and enable settings for mobile-to-mobile communications, enable private local area progressives or other group game features, enable a pooling of money between players, etc.

In some embodiments, the system modifies, and/or suggests modification of, a profile based on non-wagering conditions. For example, the system modifies a profile based on accessibility needs of the player (e.g., for a player whose profile indicates they are hard of hearing, the system modifies mobile device settings to enhance audio, vibrate, etc., to enhance or augment the gaming experience).

In some embodiments, the system can modify, and/or suggest modification of, a profile based on player characteristics. For example, the system can modify a profile based on a role or status of a player (e.g., whether the player is a high-roller, whether the player belongs to a family or group, etc.), an age of a player (e.g., a minor's mobile device cannot enable e-wallet features, parental controls become enabled, etc.), a history of a player (e.g., a degree or level of gambling, a degree or amount of game accomplishments, etc.), and so forth.

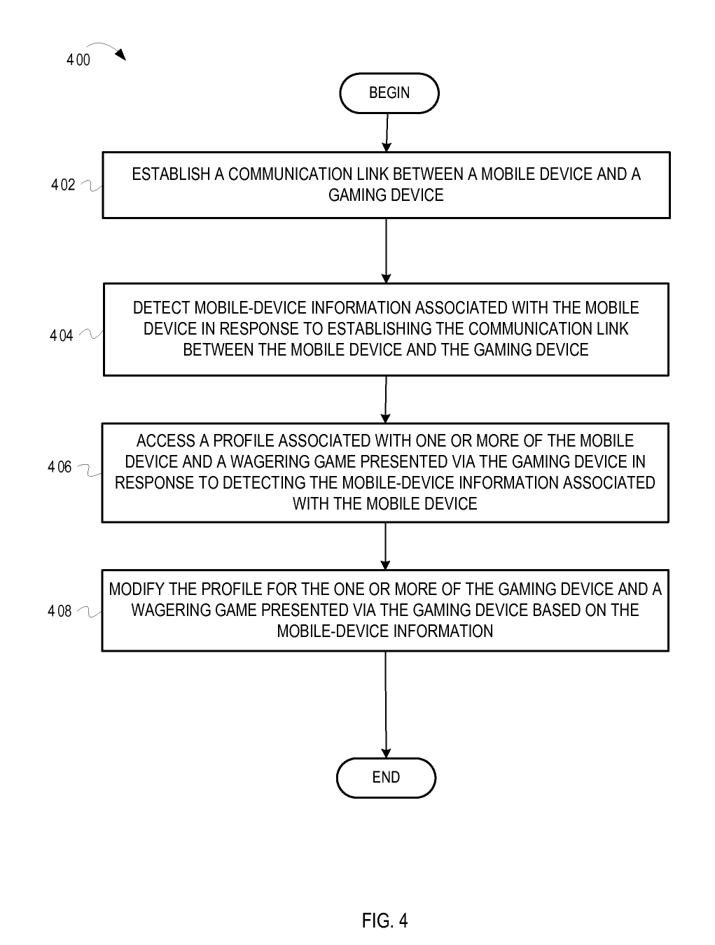

FIG. 4 is a flow diagram (“flow”) 400 illustrating modifying profile settings of a gaming device based on information from a mobile device, according to some embodiments. In FIG. 4, the flow 400 begins at processing block 402, where a wagering game system (“system”) establishes a communication link between a mobile device and a gaming device, as similarly described in FIG. 3.

The flow 400 continues at processing block 404, where the system detects mobile-device information associated with the mobile device in response to establishing the communication link between the mobile device and the gaming device, as similarly described in FIG. 2.

The flow 400 continues at processing block 406, where the system accesses a profile associated with one or more of the gaming device and a wagering game presented via the gaming device in response to detecting the mobile-device information associated with the mobile device, as similarly described in FIG. 2.

The flow 400 continues at processing block 408, where the system automatically modifies the profile for the one or more of the gaming device and a wagering game presented via the gaming device based on the mobile-device information, as similarly described in FIG. 2.

In some embodiments, the system determines that one or more settings of the profile indicate a preference to prevent interruptions via the mobile device during a wagering game session and disables one or more features of the one or more of the wagering game and the gaming device in response to determining that the one or more settings of the profile indicate the preference to prevent interruptions. For instance, if the settings of a profile of a mobile device indicate that a ringer is turned off during a gaming session and that reminder settings for a calendar, or other applications or functions, are muted or delayed, then the system interprets those settings as being an indication that the player prefers to not be disturbed and are set as such to prevent disruptions to gaming activity while the player is gambling. Based on that interpretation, the system can disable certain game features, such as presentation of certain game animations that may add to the feel and fun of a game but that delay the opportunity to gamble more quickly. In another example, the system may disable a chat function available via the wagering game, minimize a size of advertisements on a display of the wagering game machine, hold non-urgent messages, etc.

### ADDITIONAL EXAMPLE EMBODIMENTS

According to some embodiments, a wagering game system (“system”) can provide various example devices, operations, etc., to modify profiles of gaming-related devices. The following non-exhaustive list enumerates some possible embodiments.

Network Profiles Affect Function of Devices.

In some embodiments, the settings of a profile can be stored and accessed via a network instead of, or in addition to, being stored on a mobile device and/or a gaming device. For example, instead of a setting on a mobile device that shuts off a ringer, the system stores a setting on a communications network (e.g., telephone network) that will forward calls to a voice mail associated with the player and/or the mobile device.

Push Content to a Mobile Device Based on Changes to a Profile or Potential Changes to a Profile.

In some embodiments, the system pushes needed content or assets to the mobile device. For example, as a mobile device approaches an area, the system pushes content to the mobile device so that the mobile device is ready to play the content in conjunction with a wagering game. In some embodiments, the system can download content to a mobile device to ensure that the mobile device's profile can effectuate its settings (e.g., if a mobile device does not have a specific song file associated with a win for the wagering game, then the wagering game machine pushes that song file to the mobile device to play at the appropriate time via a media application, via a ring tone presentation, etc.).

Verification of Profile Changes.

In some embodiments, the system causes a time-delayed verification of profile updates. For example, during a gaming session the system may modify a profile on a mobile device. The system recognizes when the wagering game session ends. Sometime afterwards, such as when the player walks away from a gaming device (e.g., when the system detects movement of the mobile device away from a wagering game machine used during a wagering game session), when the player leaves the casino (e.g., when the system detects that the mobile device leaves a boundary of the casino), when the player returns home (e.g., when a GPS application on the mobile device detects when the mobile device has returned to a home address or when a home network application detects when the mobile device is docked at personal computer), etc., the mobile device generates a notification that the settings have changed (e.g., via an email, a text message, a pop-up message on a display, etc.). The system can then prompt, (e.g., via an interactive element of the email, text message, pop-up, etc.) for a verification of the changes to the profile.

Profile Changes Extend to Other Devices.

In some embodiments, the system pushes changes made to a profile of a mobile device to a profile for a second device (e.g., to a second mobile device or other personal computing device). For example, in FIG. 2, at stage “A” the mobile device 220 interacted with the wagering game machine 260 within a wagering game venue, such as within a casino. At some point, either within the casino (e.g., when the mobile device 220 approaches a second mobile device 230 within the casino), or outside of the casino (e.g., when the mobile device 220 approaches the second mobile device 230 or when the mobile device 220 approaches the laptop 231 outside the casino, such as in a hotel room, at home, etc.), the mobile device 220 pushes the changes previously made to the profile 221 to the other computing devices (e.g., to the second mobile device 230 and/or to the laptop 231, to a television top-box, to a desktop computer, to a vehicle computer, or other devices that utilize similar settings.). If the other computing device has features that the mobile device 220 did not have, the system can make additional modifications to profiles of the other computing devices based on their capabilities. In another example, a player may play a specific wagering game in a casino during which modifications are made to the profile 221 for the mobile device 220. When the player arrives at home, as soon as player walks within wireless range of an at-home device that can wirelessly communicate with the mobile device 220 (e.g., a high-definition television, a personal computer, a game console, etc.), an application launches on the at-home device and performs an operation that uses one or more settings on the profile 221. For example, a personal computer starts a game application (e.g., a browser application launches for a gaming website) that initiates a “for-fun” (non-wagering) version of the wagering game played at the casino. In another example, a version of content that appeared in the wagering game appears on a display of the at-home device (e.g., at the casino, the player plays “Reel 'Em In,” a wagering game with an aquatic, or fish-based theme, during which fishing-related content is downloaded to the mobile device 220 and an indication is made in the profile 221 to communicate the fishing-related content to an at-home device and cause the fishing-related content to appear as a background graphic on a display for the at-home device). In some embodiments, the system can turn on an auto-wager feature on an application stored on the mobile device 220 and update the profile 221 so that the application can make automatic wagers when certain conditions are met outside of the casino (e.g., as soon as the player gets home, the mobile device 220 detects that the player is in a jurisdiction that allows online gambling and automatically makes a wager).

In some embodiments, the system can also push, or transmit, changes within the modification to an account within the account server 270 which other devices, such as the second mobile device 230 or the laptop 231, can access without having to communicate with the mobile device 220.

In some embodiments, profile settings can be shared or distributed to multiple devices in one or more ways. For example, in some embodiments, profile changes can be submitted to multiple mobile devices at once (e.g., during a group or community game), but with an instruction to only modify the display settings for certain ones of the multiple devices so that only certain content appears on some of the mobile devices during a gaming session but not on others of the mobile devices. Depending on the device, the system will transmit certain settings to one device and not another. In some embodiments, the system can utilize both mobile devices in combination (e.g., to present interesting combinations of features such as stereo sounds).

Profile Changes Based on Location of Other Personal Devices.

In some embodiments, the system detects that one or more additional mobile devices are located within a given distance to the wagering game machine and/or are within a given distance to the mobile device associated with the wagering game machine and, accordingly, remove or prevent presentation of the content on the wagering game machine. The system can detect the location of additional mobile devices by sending out and receiving signals that the mobile devices respond to and/or by detecting signals sent by the mobile devices, such as power signals, radio-frequency signals, telephone signals, GPS location signals, etc. In some embodiments, the system detects the location of the additional mobile devices using a camera of the mobile device or a camera of the wagering game machine. The other mobile devices may be associated with other casino patrons who are within a given proximity to the wagering game machine or mobile device of the player (e.g., other patrons are watching the wagering game played by the player). The system can modify the profile of the mobile device and/or the profile of the wagering game machine to prevent presentation of specific content via the wagering game machine and, in some embodiments, to instead present the specific content via the mobile device. The specific content may be presented, or intended to be presented, via the wagering game machine as part of normal operations of a wagering game application and is information that relates to the player account, which a player associated with the player account may be considered to be private information. The portion of content may include, for instance (1) financial data for the player account (e.g., credit or money balances, credit card numbers, bank account data, etc.) that is presentable via the wagering game machine (e.g., via a credit meter), (2) a chat message or other social communication sent to, or from, the player account, such as via a social contact (e.g., friend, family, etc.) that is presentable via a social communication application associated with the wagering game machine, (3) player account history (e.g., a history of credit card purchases made via the player account, casino compensations made to the player and indicated via the player account, deposits to or withdrawals from the player account, etc.) that is presentable via an accounting application, (4) a gaming history (e.g., a history of gaming activity, accomplishments, wins, losses, etc.) presentable via the wagering game machine in connection with a wagering game session, and (5) responsible gaming information (e.g., warnings or settings related to responsible gaming such as warnings about wagers, withdrawals, etc. performed within a given time period) which are typically presented to notify a player of excessive gambling activity. In response, the system removes presentation of the specific content if the specific content is being displayed and prevents further display of the portion of content, or the system prevents the content from being present if not already being presented. The system refrains from presenting the content until the system detects that other mobile devices are no longer within the proximity and/or until a player, logged in to the wagering game machine, requests to present the portion of the content via the wagering game machine again. In some embodiments, the system transmits a portion of content associated with a player account logged in to the wagering game machine to the mobile device for display via the mobile device and modifies the profile for the mobile device and/or modifies a profile for the wagering game and/or the wagering game machine to prevent the portion of the content from being presented via the wagering game machine (e.g., present a credit meter via the mobile device until the other casino patrons clear out and no-one else is watching the player play the wagering game).

### Example Operating Environments

This section describes example operating environments, systems, networks, etc., and presents structural aspects of some embodiments.

### Wagering Game System Architecture

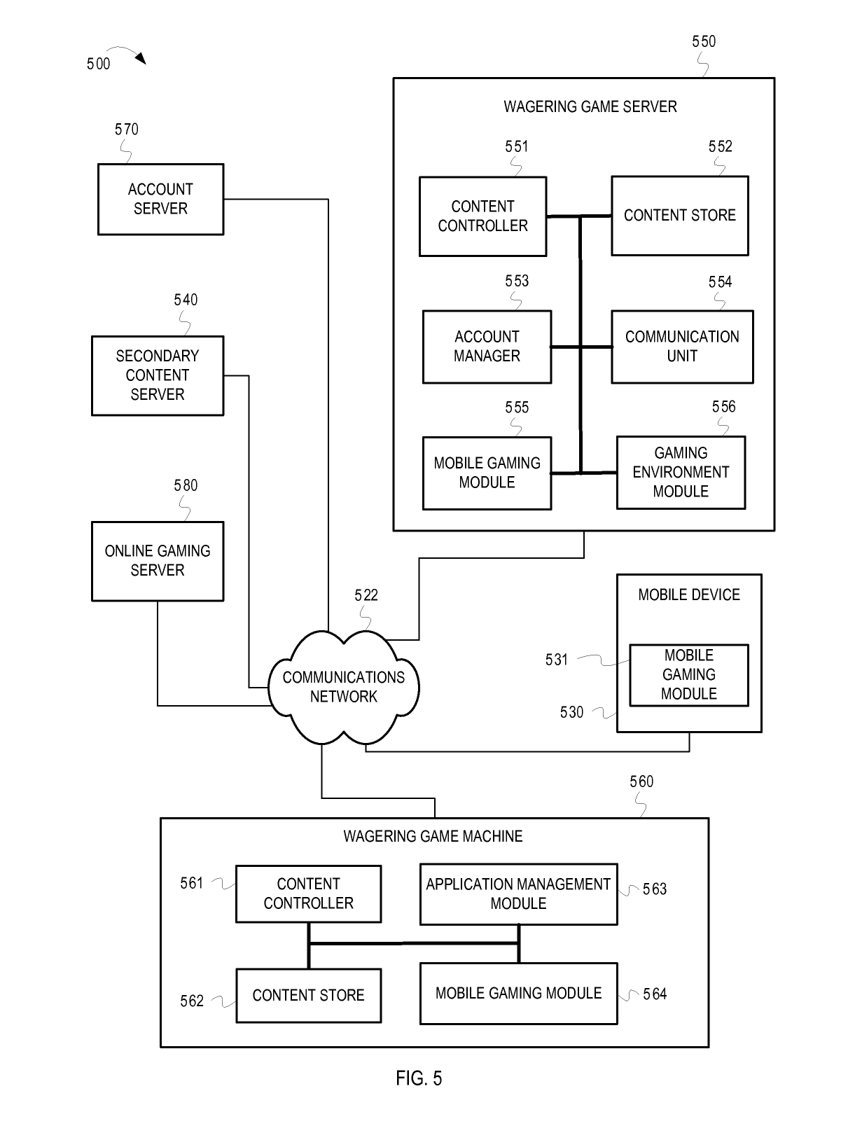

FIG. 5 is a conceptual diagram that illustrates an example of a wagering game system architecture 500, according to some embodiments. The wagering game system architecture 500 can include an account server 570 configured to control user related accounts accessible via wagering game networks and social networking networks. The account server 570 can store wagering game player account information, such as account settings (e.g., settings related to group games, etc., settings related to social contacts, etc.), preferences (e.g., player preferences regarding content presentable via an application of a mobile device, player preferences regarding award types, preferences related to virtual assets, etc.), player profile data (e.g., name, avatar, screen name, etc.), and other information for a player's account (e.g., financial information, account identification numbers, virtual assets, social contact information, etc.). The account server 570 can contain lists of social contacts referenced by a player account. The account server 570 can also provide auditing capabilities, according to regulatory rules. The account server 570 can also track performance of players, machines, and servers.

The wagering game system architecture 500 can also include a wagering game server 550 configured to control wagering game content, provide random numbers, and communicate wagering game information, account information, and other information to and from a wagering game machine 560. The wagering game server 550 can include a content controller 551 configured to manage and control content for presentation on the wagering game machine 560. For example, the content controller 551 can generate game results (e.g., win/loss values), including win amounts, for games played on the wagering game machine 560. The content controller 551 can communicate the game results to the wagering game machine 560. The content controller 551 can also generate random numbers and provide them to the wagering game machine 560 so that the wagering game machine 560 can generate game results. The wagering game server 550 can also include a content store 552 configured to contain content to present on the wagering game machine 560. The wagering game server 550 can also include an account manager 553 configured to control information related to player accounts. For example, the account manager 553 can communicate wager amounts, game results amounts (e.g., win amounts), bonus game amounts, etc., to the account server 570. The wagering game server 550 can also include a communication unit 554 configured to communicate information to the wagering game machine 560 and to communicate with other systems, devices and networks. The wagering game server 550 can also include a mobile gaming module 555 configured to read from, and write to, profiles for gaming devices and mobile devices. The wagering game server 550 can also include a gaming environment module 556 configured to present environmental light and sound effects in a casino environment. The gaming environment module 556 is further configured to provide content data, user data, and control information regarding gaming effects within a casino environment. For example, the gaming environment module 556 can coordinate a synchronized presentation of lighting and sound effects across a bank of wagering game machines and/or other lighting and sound producing devices within one or more areas of a casino. The gaming environment module 556 can also be configured to detect gaming events, such as events generated by the wagering game server 550 and/or the wagering game machine 560. The gaming environment module 556 can generate data for a synchronized light/sound show based on the gaming events. The gaming environment module 556 can control environmental light presentation devices within a casino. The gaming environment module 556 can provide emotive lighting presentation data, including light presentation commands on emotive lighting devices on or near wagering game machines, as well as other devices within the casino such as spotlights, overhead emotive lighting, projectors, etc. The gaming environment module 556 can be configured to determine multi-media, casino-content, including casino-wide special effects that include sound effects and light effects. The multi-media casino content can be presentable across a plurality of casino content presentation devices (“presentation devices”) in a casino. The multi-media, casino-content effect can be related to a wagering game presentation or event. The wagering game presentation or event can be tied to the functionality, activity, or purpose of a wagering game. For instance, wagering game presentations can be related to attracting wagering game players to groups of wagering game machines, presenting game related outcomes across multiple wagering game machines, expressing group gaming activity across multiple wagering game machines, focusing attention on a particular person or machine in response to a gaming event, etc. The presentation devices present sound and light effects that accompany a gaming event (e.g., a jackpot celebratory effect that focuses on a wagering game machine, a lightning strike that introduces a community gaming event, and a musical chair game that reveals a community wagering game winner). The gaming environment module 556 can also be configured to determine timing control data for the multi-media effect. In some embodiments, timing control data can be stored on the wagering game server 550, or be accessible to the gaming environment module 556 via another device (e.g., a lighting controller associated with a bank of wagering game machines), to use to send lighting commands in sequential order to network addresses of presentation device on a casino network. The gaming environment module 556 can determine channels assigned with casino-content presentation devices, such as the wagering game machine 560. In some embodiments, the presentation devices can have addresses assigned to a channel. For example, the wagering game machine 560 could be on one channel, peripheral devices could be on another channel, network light presentation devices can be on other channels, etc. In some embodiments, the gaming environment module 556 can be a DMX controller connected in parallel to an emotive lighting controller on, or associated with, the wagering game machine 560. The DMX controller can also be connected in parallel to a plurality of other presentation devices (e.g., other wagering game machines, lighting presentation devices, etc.) within a casino, and can simultaneously provide DMX lighting commands to the wagering game machine 560 and to the other presentation devices. DMX can change light intensity, or other light characteristics, over time. Some embodiments of DMX controllers can update commands very quickly (e.g., 30-47 times a second) across multiple channels (e.g., 512 channels). A DMX controller can put different commands in every channel (e.g., one channel can have show “X,” one channel can have show “Y,” etc.). The DMX can also have a frame number within a show. Some devices can take up more than one channel (e.g., an emotive light might have three colors and may take up a channel for each color, a spotlight might have seven channels, etc.). Each device can receive 512 bytes of data from the DMX controller at any given time interval (e.g., frame). The 512 bytes of data can be divided in different ways. For example, 6 bytes may address light effect behavior, 6 bytes may include show numbers, 6 bytes may include frame numbers, 1 byte may include priority values, and so on for various light effect characteristics (e.g., intensity, color, pan, tilt, etc.). The presentation device that receives the DMX command data is programmed to interpret the lighting data in the channel. In some embodiments, the presentation devices can be DMX compliant including having a DMX input port to accept DMX commands. In some embodiments, presentation devices can convert the DMX commands to proprietary commands. In addition to the DMX protocol, other types of dedicated lighting protocols can include AMX 192, CMX, SMX, PMX, protocols included in the EIA-485 standard, etc.

The wagering game system architecture 500 can also include the wagering game machine 560 configured to present wagering games and receive and transmit information between the wagering game machine 560 and a mobile device 530. The wagering game machine 560 can include a content controller 561 configured to manage and control content and presentation of content on the wagering game machine 560. The wagering game machine 560 can also include a content store 562 configured to contain content to present on the wagering game machine 560. The wagering game machine 560 can also include an application management module 563 configured to manage multiple instances of gaming applications. For example, the application management module 563 can be configured to launch, load, unload and control applications and instances of applications. The application management module 563 can launch different software players (e.g., a Microsoft® Silverlight™ player, an Adobe® Flash® player, etc.) and manage, coordinate, and prioritize what the software players do. The application management module 563 can also coordinate instances of server applications in addition to local copies of applications. The application management module 563 can control window locations on a wagering game screen or display for the multiple gaming applications. In some embodiments, the application management module 563 can manage window locations on multiple displays including displays on devices associated with and/or external to the wagering game machine 560 (e.g., a top display and a bottom display on the wagering game machine 560, a peripheral device connected to the wagering game machine 560, a mobile device connected to the wagering game machine 560, etc.). The application management module 563 can manage priority or precedence of client applications that compete for the same display area. For instance, the application management module 563 can determine each client application's precedence. The precedence may be static (i.e. set only when the client application first launches or connects) or dynamic. The applications may provide precedence values to the application management module 563, which the application management module 563 can use to establish order and priority. The precedence, or priority, values can be related to tilt events, administrative events, primary game events (e.g., hierarchical, levels, etc.), secondary game events, local bonus game events, advertising events, etc. As each client application runs, it can also inform the application management module 563 of its current presentation state. The applications may provide presentation state values to the application management module 563, which the application management module 563 can use to evaluate and assess priority. Examples of presentation states may include celebration states (e.g., indicates that client application is currently running a win celebration), playing states (e.g., indicates that the client application is currently playing), game starting states (e.g., indicates that the client application is showing an invitation or indication that a game is about to start), status update states (e.g., indicates that the client application is not ‘playing’ but has a change of status that should be annunciated, such as a change in progressive meter values or a change in a bonus game multiplier), idle states (e.g., indicates that the client application is idle), etc. In some embodiments, the application management module 563 can be pre-configurable. The system can provide controls and interfaces for operators to control screen layouts and other presentation features for the configuring of the application management module 563. The application management module 563 can communicate with, and/or be a communication mechanism for, a base game stored on a wagering game machine. For example, the application management module 563 can communicate events from the base game such as the base game state, pay line status, bet amount status, etc. The application management module 563 can also provide events that assist and/or restrict the base game, such as providing bet amounts from secondary gaming applications, inhibiting play based on gaming event priority, etc. The application management module 563 can also communicate some (or all) financial information between the base game and other applications including amounts wagered, amounts won, base game outcomes, etc. The application management module 563 can also communicate pay table information such as possible outcomes, bonus frequency, etc. In some embodiments, the application management module 563 can control different types of applications. For example, the application management module 563 can perform rendering operations for presenting applications of varying platforms, formats, environments, programming languages, etc. For example, the application management module 563 can be written in one programming language format (e.g., JavaScript, Java, C++, etc.) but can manage, and communicate data from, applications that are written in other programming languages or that communicate in different data formats (e.g., Adobe® Flash®, Microsoft® Silverlight™, Adobe® Air™, hyper-text markup language, etc.). The application management module 563 can include a portable virtual machine capable of generating and executing code for the varying platforms, formats, environments, programming languages, etc. The application management module 563 can enable many-to-many messaging distribution and can enable the multiple applications to communicate with each other in a cross-manufacturer environment at the client application level. For example, multiple gaming applications on a wagering game machine may need to coordinate many different types of gaming and casino services events (e.g., financial or account access to run spins on the base game and/or run side bets, transacting drink orders, tracking player history and player loyalty points, etc.).

The wagering game machine 560 can also include a mobile gaming module 564 configured to detect mobile device information from the mobile device 530 and transmit wagering-game related information to the mobile device 530. Further, the mobile gaming module 564 is configured to modify a profile for the wagering game machine 560 based on information from the mobile device, request modifications to a profile of the mobile device 530, modify a profile of the mobile device 530, and verify settings of a profile of the mobile device 530.

The wagering game system architecture 500 can also include a secondary content server 540 configured to provide content and control information for secondary games and other secondary content available on a wagering game network (e.g., secondary wagering game content, promotions content, advertising content, player tracking content, web content, etc.). The secondary content server 580 can provide “secondary” content, or content for “secondary” games presented on the wagering game machine 560. “Secondary” in some embodiments can refer to an application's importance or priority of the data. In some embodiments, “secondary” can refer to a distinction, or separation, from a primary application (e.g., separate application files, separate content, separate states, separate functions, separate processes, separate programming sources, separate processor threads, separate data, separate control, separate domains, etc.). Nevertheless, in some embodiments, secondary content and control can be passed between applications (e.g., via application protocol interfaces), thus becoming, or falling under the control of, primary content or primary applications, and vice versa. In some embodiments, the secondary content can be in one or more different formats, such as Adobe® Flash®, Microsoft® Silverlight™, Adobe® Air™, hyper-text markup language, etc. In some embodiments, the secondary content server 580 can provide and control content for community games, including networked games, social games, competitive games, or any other game that multiple players can participate in at the same time. In some embodiments, the secondary content server 580 can control and present an online website that hosts wagering games. The secondary content server 580 can also be configured to present multiple wagering game applications on the wagering game machine 560 via a wagering game website, or other gaming-type venue accessible via the Internet. The secondary content server 580 can host an online wagering website and/or a social networking website. The secondary content server 580 can include other devices, servers, mechanisms, etc., that provide functionality (e.g., controls, web pages, applications, etc.) that web users can use to connect to a social networking application and/or website and utilize social networking and website features (e.g., communications mechanisms, applications, etc.). The secondary content server 580 can also be configured to provide content presentable via an application of a mobile device. In some embodiments, the secondary content server 580 can also host social networking accounts, provide social networking content, control social networking communications, store associated social contacts, etc. The secondary content server 580 can also provide chat functionality for a social networking website, a chat application, or any other social networking communications mechanism. In some embodiments, the secondary content server 580 can utilize player data to determine marketing promotions that may be of interest to a player account. The secondary content server 580 can also analyze player data and generate analytics for players, group players into demographics, integrate with third party marketing services and devices, etc. The secondary content server 580 can also provide player data to third parties that can use the player data for marketing. In some embodiments, the secondary content server 580 can provide one or more social networking communication mechanisms that publish (e.g., post, broadcast, etc.) a message to a mass (e.g., to multiple people, users, social contacts, accounts, etc.). The social networking communication mechanism can publish the message to the mass simultaneously. Examples of the published message may include, but not be limited to, a blog post, a mass message post, a news feed post, a profile status update, a mass chat feed, a mass text message broadcast, a video blog, a forum post, etc. Multiple users and/or accounts can access the published message and/or receive automated notifications of the published message.

The wagering game system architecture 500 can also include an online gaming server 580 configured to control and present a website that hosts gaming related content (e.g., wagering games, non-wagering games that share common themes to wagering games, social networking content related to gaming, etc.). The online gaming server 580 can be configured to present multiple applications on the website via the Internet. The online gaming server 580 can host a social network. The online gaming server 580 can include other devices, servers, mechanisms, etc., that provide functionality (e.g., controls, web pages, applications, etc.) that web users can use to connect to a social networking application and/or website and utilize social networking and website features (e.g., communications mechanisms, applications, etc.). The online gaming server 580 can also be configured to provide content presentable via an application of the mobile device 530.

The wagering game system architecture 500 can also include the mobile device 530 configured to control mobile communications and applications. The mobile device 530 may also be referred to as a handheld device, a handheld computer or simply handheld. In some embodiments, the mobile device 530 is a pocket-sized computing device, having a display screen with touch input and/or a miniature keyboard. Some examples of the mobile device 530 may include, but are not limited to, a smartphone, a personal digital assistant, a mobile computer, a mobile internet device, a portable media player, a mobile phone, a pager, a personal navigation device, etc. In some embodiments, the mobile device 530 functions via a wireless application protocol (WAP). In some embodiments, the mobile device 530 may include integrated data capture devices like barcode readers, radio frequency identification (RFID) readers, In-cell Optical LCD readers, and smart card readers. In some embodiments the mobile device 530 is personal (i.e., belongs to a user), which the user can carry on their person. The mobile device 530 can include a mobile gaming module 531 configured to detect gaming-related information from the wagering game machine 560 and transmit mobile-device related information to the wagering game machine 560. Further, the mobile gaming module 531 is configured to modify a profile for the mobile device 530, request modifications to a profile of the wagering game machine 560, and verify settings of a profile of the wagering game machine 560. In some embodiments, the mobile gaming module 531 is further configured to present content related to gaming, via an application of the mobile device 530, while the mobile device 530 is inside or outside the casino. In some embodiments, the mobile gaming module 531 is further configured to transfer settings of a profile to other devices.

Each component shown in the wagering game system architecture 500 is shown as a separate and distinct element connected via a communications network 522. However, some functions performed by one component could be performed by other components. For example, the wagering game server 550 can also be configured to perform functions of the application management module 563, and other network elements and/or system devices. Furthermore, the components shown may all be contained in one device, but some, or all, may be included in, or performed by, multiple devices, as in the configurations shown in FIG. 5 or other configurations not shown. For example, the account manager 553 and the communication unit 554 can be included in the wagering game machine 560 instead of, or in addition to, being a part of the wagering game server 550. Further, in some embodiments, the wagering game machine 560 can determine wagering game outcomes, generate random numbers, etc. instead of, or in addition to, the wagering game server 550.

The wagering game machines described herein (e.g., wagering game machine 560) can take any suitable form, such as floor standing models, handheld mobile wagering game machines, bar-top models, workstation-type console models, surface computing machines, etc. Further, wagering game machines can be primarily dedicated for use in conducting wagering games.

In some embodiments, wagering game machines and wagering game servers work together such that wagering game machines can be operated as thin, thick, or intermediate clients. For example, one or more elements of game play may be controlled by the wagering game machines (client) or the wagering game servers (server). Game play elements can include executable game code, lookup tables, configuration files, game outcome, audio or visual representations of the game, game assets or the like. In a thin-client example, the wagering game server can perform functions such as determining game outcome or managing assets, while the wagering game machines can present a graphical representation of such outcome or asset modification to the user (e.g., player). In a thick-client example, the wagering game machines can determine game outcomes and communicate the outcomes to the wagering game server for recording or managing a player's account.

In some embodiments, either the wagering game machines (client) or the wagering game server(s) can provide functionality that is not directly related to game play. For example, account transactions and account rules may be managed centrally (e.g., by the wagering game server(s)) or locally (e.g., by the wagering game machines). Other functionality not directly related to game play may include power management, presentation of advertising, software or firmware updates, system quality or security checks, etc.

Furthermore, the wagering game system architecture 500 can be implemented as software, hardware, any combination thereof, or other forms of embodiments not listed. For example, any of the network components (e.g., the wagering game machines, servers, etc.) can include hardware and machine-readable storage media including instructions for performing the operations described herein.

### Wagering Game Computer System

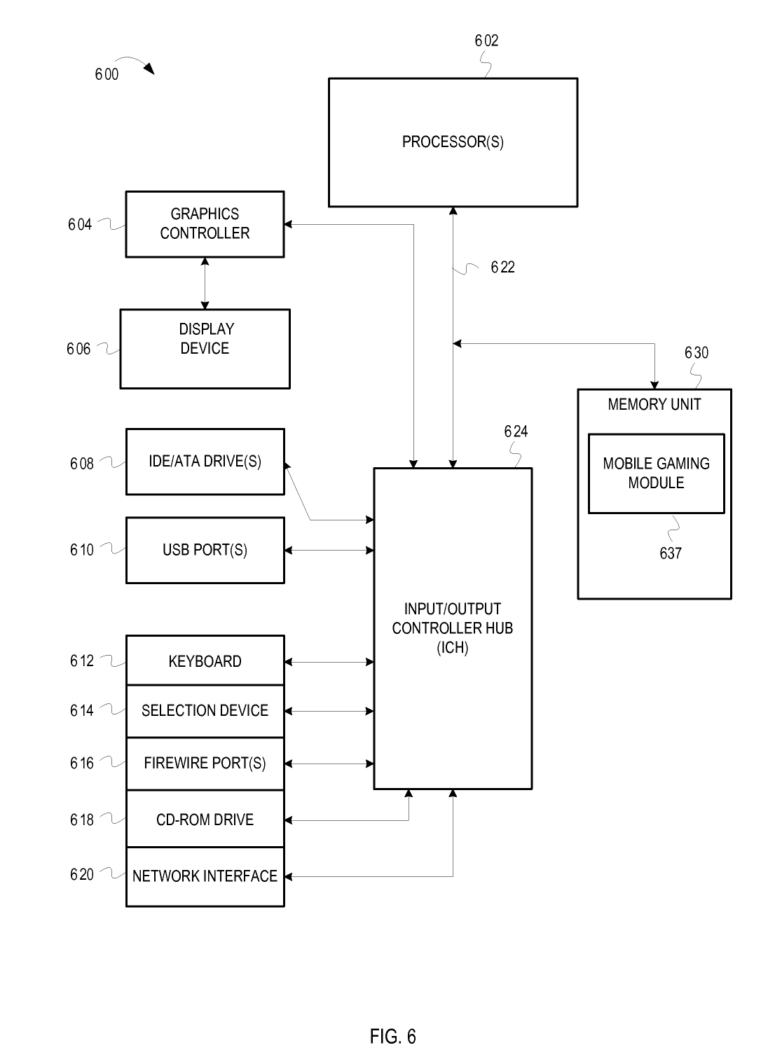

FIG. 6 is a conceptual diagram that illustrates an example of a wagering game computer system 600, according to some embodiments. In FIG. 6, the wagering game computer system (“computer system”) 600 may include a processor unit 602, a memory unit 630, a processor bus 622, and an Input/Output controller hub (ICH) 624. The processor unit 602, memory unit 630, and ICH 624 may be coupled to the processor bus 622. The processor unit 602 may comprise any suitable processor architecture. The computer system 600 may comprise one, two, three, or more processors, any of which may execute a set of instructions in accordance with some embodiments.

The memory unit 630 may also include an I/O scheduling policy unit and I/O schedulers. The memory unit 630 can store data and/or instructions, and may comprise any suitable memory, such as a dynamic random access memory (DRAM), for example. The computer system 600 may also include one or more suitable integrated drive electronics (IDE) drive(s) 608 and/or other suitable storage devices. A graphics controller 604 controls the display of information on a display device 606, according to some embodiments.

The ICH 624 provides an interface to I/O devices or peripheral components for the computer system 600. The ICH 624 may comprise any suitable interface controller to provide for any suitable communication link to the processor unit 602, memory unit 630 and/or to any suitable device or component in communication with the ICH 624. The ICH 624 can provide suitable arbitration and buffering for each interface.

For one embodiment, the ICH 624 provides an interface to the one or more IDE drives 608, such as a hard disk drive (HDD) or compact disc read only memory (CD ROM) drive, or to suitable universal serial bus (USB) devices through one or more USB ports 610. For one embodiment, the ICH 624 also provides an interface to a keyboard 612, a selection device 614 (e.g., a mouse, trackball, touchpad, etc.), CD-ROM drive 618, and one or more suitable devices through one or more firewire ports 616. For one embodiment, the ICH 624 also provides a network interface 620 through which the computer system 600 can communicate with other computers and/or devices.

The computer system 600 may also include a machine-readable storage medium that stores a set of instructions (e.g., software) embodying any one, or all, of the methodologies to modify profiles of gaming-related devices. Furthermore, software can reside, completely or at least partially, within the memory unit 630 and/or within the processor unit 602. The computer system 600 can also include a wagering game module 637. The wagering game module 637 can process communications, commands, or other information, to modify profiles of gaming-related devices. Any component of the computer system 600 can be implemented as hardware, firmware, and/or machine-readable storage media including instructions for performing the operations described herein.

### Wagering Game Machine Architecture

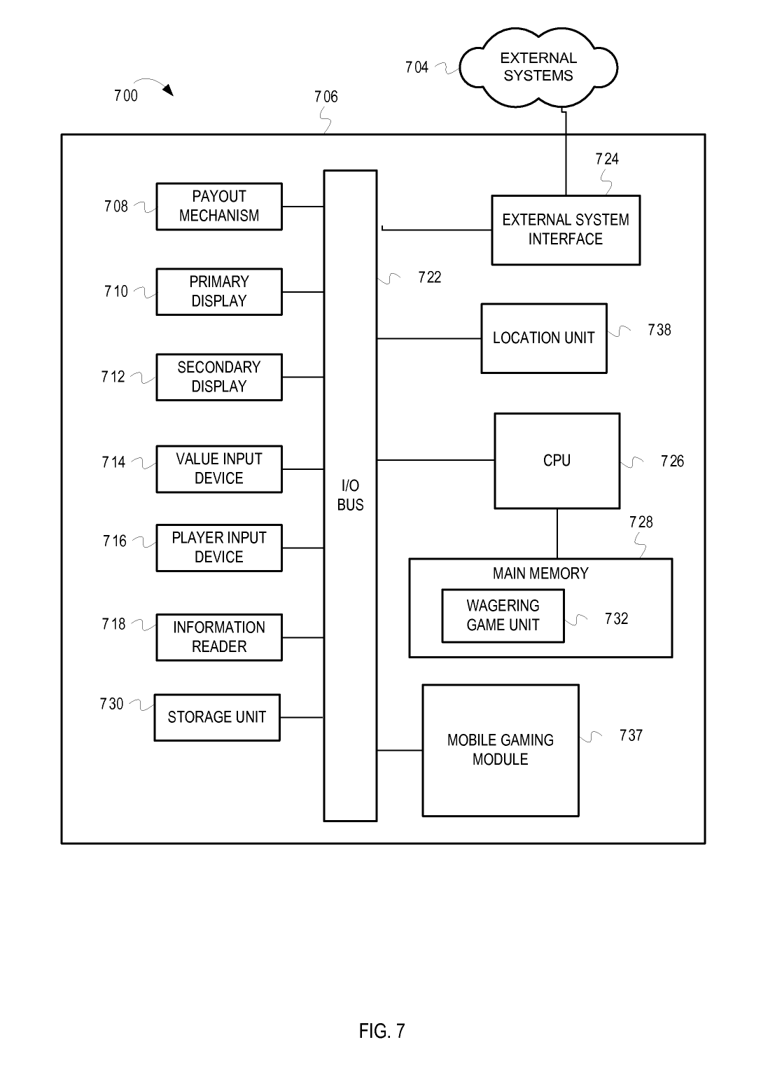

FIG. 7 is a conceptual diagram that illustrates an example of a wagering game machine architecture 700, according to some embodiments. In FIG. 7, the wagering game machine architecture 700 includes a wagering game machine 706, which includes a central processing unit (CPU) 726 connected to main memory 728. The CPU 726 can include any suitable processor, such as an Intel® Pentium processor, Intel® Core 2 Duo processor, AMD Opteron™ processor, or UltraSPARC processor. The main memory 728 includes a wagering game unit 732. In some embodiments, the wagering game unit 732 can present wagering games, such as video poker, video black jack, video slots, video lottery, reel slots, etc., in whole or part.

The CPU 726 is also connected to an input/output (“I/O”) bus 722, which can include any suitable bus technologies, such as an AGTL+ frontside bus and a PCI backside bus. The I/O bus 722 is connected to a payout mechanism 708, primary display 710, secondary display 712, value input device 714, player input device 716, information reader 718, and storage unit 730. The player input device 716 can include the value input device 714 to the extent the player input device 716 is used to place wagers. The I/O bus 722 is also connected to an external system interface 724, which is connected to external systems 704 (e.g., wagering game networks). The external system interface 724 can include logic for exchanging information over wired and wireless networks (e.g., 802.11g transceiver, Bluetooth transceiver, Ethernet transceiver, etc.)

The I/O bus 722 is also connected to a location unit 738. The location unit 738 can create player information that indicates the wagering game machine's location/movements in a casino. In some embodiments, the location unit 738 includes a global positioning system (GPS) receiver that can determine the wagering game machine's location using GPS satellites. In other embodiments, the location unit 738 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location. Although not shown in FIG. 7, in some embodiments, the location unit 738 is not connected to the I/O bus 722.

In some embodiments, the wagering game machine 706 can include additional peripheral devices and/or more than one of each component shown in FIG. 7. For example, in some embodiments, the wagering game machine 706 can include multiple external system interfaces 724 and/or multiple CPUs 726. In some embodiments, any of the components can be integrated or subdivided.

In some embodiments, the wagering game machine 706 includes a mobile gaming module 737. The mobile gaming module 737 can process communications, commands, or other information, where the processing can modify profiles of gaming-related devices.

Furthermore, any component of the wagering game machine 706 can include hardware, firmware, and/or machine-readable storage media including instructions for performing the operations described herein.

### Wagering Game System

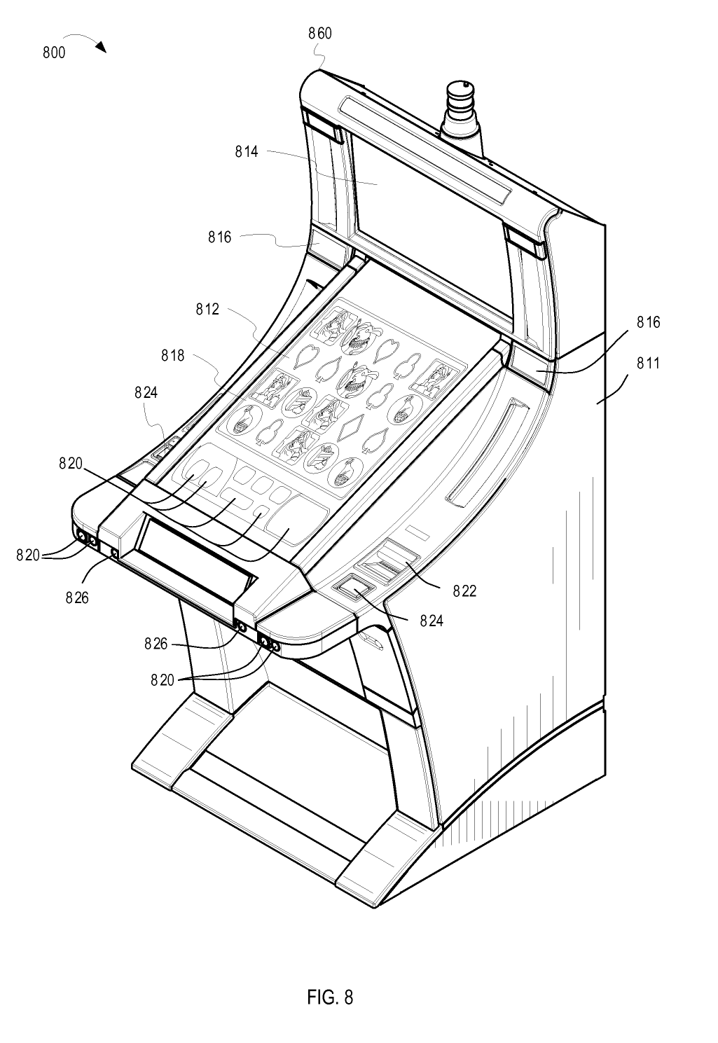

FIG. 8 is a conceptual diagram that illustrates an example of a wagering game system 800, according to some embodiments. In FIG. 8, the wagering game system 800 includes a wagering game machine 860 similar to those used in gaming establishments, such as casinos. The wagering game machine 860 may, in some examples, be referred to as a gaming terminal or an electronic gaming machine. The wagering game machine 860 may have varying structures and methods of operation. For example, the wagering game machine 860 may include electromechanical components configured to play mechanical slots. In another example, the 860 includes electronic components configured to play a video casino game, such as slots, keno, poker, blackjack, roulette, craps, etc. The wagering game machine 860 is depicted as a floor-standing model. However, other examples of wagering game machines include handheld mobile units, bartop models, workstation-type console models, etc. Further, the wagering game machine 860 may be primarily dedicated for use in conducting wagering games, or may include non-dedicated devices, such as mobile phones, personal digital assistants, personal computers, etc. Exemplary types of wagering game machines are disclosed in U.S. Pat. No. 6,517,433 and Patent Application Publication Nos. US2010/0062196 and US2010/0234099, which are incorporated herein by reference in their entireties.

The wagering game machine 860 illustrated in FIG. 8 comprises a cabinet 811 that may house various input devices, output devices, and input/output devices. By way of example, the wagering game machine 860 includes a primary display area 812, a secondary display area 814, and one or more audio speakers 816. The primary display area 812 or the secondary display area 814 may include one or more of a cathode ray tube (CRT), a high resolution liquid crystal display (LCD), a plasma display, a light emitting diode (LED) display, a three-dimensional (3D) display, a video display, or a combination thereof. In some examples, the primary display area 812 or the secondary display area 814 includes mechanical reels to display a wagering game outcome. In some example, the primary display area 812 or the secondary display area 814 present a transmissive video display disposed in front of a mechanical-reel display to portray a video image superimposed upon the mechanical-reel display. In FIG. 8, the wagering game machine 860 is a “slant-top” version in which the primary display 812 is slanted (e.g., at about a thirty-degree angle toward the player of the wagering game machine 860). Another example of wagering game machine 860 is an “upright” version in which the primary display 814 is oriented vertically relative to the player. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the wagering game machine 860. The wagering game machine 860 includes a touch screen(s) 818 mounted over the primary or secondary areas, buttons 820 on a button panel, bill validator 822, information reader/writer(s) 824, and player-accessible port(s) 826 (e.g., audio output jack for headphones, video headset jack, USB port, wireless transmitter/receiver, etc.). It should be understood that numerous other peripheral devices and other elements exist and are readily utilizable in any number of combinations to create various forms of a wagering game machine in accord with the present concepts.

Input devices, such as the touch screen 818, buttons 820, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer readable program code embodied in the medium. The described embodiments may be provided as a computer program product that may include a machine-readable storage medium having stored thereon instructions, which may be used to program a computer system to perform a process according to embodiments(s), whether presently described or not, because every conceivable variation is not enumerated herein. A machine-readable storage medium includes any mechanism that stores information in a form readable by a machine (e.g., a wagering game machine, computer, etc.). For example, machine-readable storage media includes read only memory (ROM), random access memory (RAM), magnetic disk storage media, optical storage media (e.g., CD-ROM), flash memory machines, erasable programmable memory (e.g., EPROM and EEPROM); etc. Some embodiments of the invention can also include machine-readable signal media, such as any media suitable for transmitting software over a network.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments, which are defined only by the appended claims. Each of the embodiments described herein are contemplated as falling within the inventive subject matter, which is set forth in the following claims.

1. A computer-implemented method comprising:
establishing a communication link between a mobile device and a wagering game machine;
obtaining, by one or more processors, gaming information associated with a wagering game presented via the wagering game machine;
accessing, by at least one of the one or more processors, a profile for the mobile device, wherein the profile specifies one or more settings of the mobile device; and
modifying, by at least one of the one or more processors, the profile for the mobile device based on the gaming information.

2. The computer-implemented method of claim 1 wherein the gaming information is selected from a group consisting of one or more of events, messages, content, outcomes, funds, credit balances, and account data for the one or more of the wagering game and the wagering game machine.

3. The computer-implemented method of claim 1, wherein the modifying the profile for the mobile device based on the gaming information comprises:
modifying the one or more settings of the profile for the mobile device based on one or more of gaming history and player input of a player account associated with a wagering game session for the wagering game, wherein the player account is associated with a player to whom the mobile device is assigned.

4. The computer-implemented method of claim 1, wherein the modifying the profile for the mobile device based on the gaming information comprises:
modifying the one or more settings of the profile for the mobile device based on one or modes of presentation for content of the wagering game, wherein the one or more settings are related to one or more functions of the mobile device.

5. The computer-implemented method of claim 1, wherein the modifying the profile for the mobile device based on the gaming information comprises:
modifying the one or more settings of the profile for the mobile device to adjust a volume level for the mobile device to a volume level associated with the one or more of the wagering game and the wagering game machine.

6. The computer-implemented method of claim 1 further comprising:
determining a malfunction of the wagering game machine, wherein the malfunction affects presentation of at least a portion of content of the wagering game;
transferring the at least a portion of the content of the wagering game to the mobile device; and
modifying the profile for the mobile device to present the at least a portion of the content via the mobile device in response to the transferring of the at least a portion of the content.

7. The computer-implemented method of claim 1 wherein the establishing occurs in response to detecting that the mobile device is within a proximity to the at least a portion of the wagering game machine, and wherein the obtaining occurs in response to the establishing.

8. The computer-implemented method of claim 1 further comprising:
accessing the one or more settings of the profile for the mobile device, wherein the one or more settings are related to one or more capabilities of the mobile device;
comparing the one or more settings to at least one characteristic of one or more of the wagering game the wagering game machine; and
modifying the one or more settings in response to the comparing.

9. One or more machine-readable storage media having instructions stored thereon, which when executed by a set of one or more processors causes the set of one or more processors to perform operations comprising:
detecting that a mobile device is within a proximity to at least a portion of a wagering game machine;
accessing a profile for the mobile device in response to detecting that the mobile device is within the proximity to the at least a portion of the wagering game machine, wherein the profile specifies one or more settings for the mobile device;
detecting gaming information associated with the wagering game machine; and
modifying the profile for the mobile device based on the gaming information.

10. The one or more machine-readable storage media of claim 9, said operations further comprising:
prior to modifying the profile for the mobile device, determining one or more potential modifications to make to the profile based on the gaming information;
presenting a suggestion of the one or more potential modifications; and
detecting an authorization of at least one of the one or more potential modifications, wherein the operation for modifying the profile for the mobile device includes making the at least one of the one or more proposed modifications in response to detecting the authorization.

11. The one or more machine-readable storage media of claim 9, said operations further comprising:
after modifying the profile for the mobile device, detecting that the mobile device is beyond the proximity to the at least a portion of the wagering game machine;
in response to detecting that the mobile device is beyond the proximity to the at least a portion of the wagering game machine, presenting a notification that the profile for the mobile device has been modified; and
requesting, via the notification, a verification of the modifying of the profile for the mobile device.

12. The one or more machine-readable storage media of claim 9, said operations further comprising:
after modifying the profile for the mobile device, detecting that the mobile device is in proximity to an additional device that has an additional profile, wherein the one or more settings of the profile for the mobile device that were modified via the modification of the profile for the mobile device are usable by the additional profile;
establishing a communication link with the additional device; and
modifying the additional profile with the one or more settings of the profile for the mobile device via the communication link.

13. The one or more machine-readable storage media of claim 12, said operations further comprising:
determining that the additional mobile device has functionality that the mobile device lacks; and
modifying one or more additional settings of the profile of the additional device in response to modifying the additional profile with the one or more settings of the profile for the mobile device, wherein the one or more additional settings correspond to the functionality that the mobile device lacks.

14. The one or more machine-readable storage media of claim 9, wherein the one or more settings correspond to one or more hardware components of the mobile device.

15. A system comprising:
at least one input device configured to receive an indication of a wager to play a wagering game;
at least one display device configured to display the wagering game;
at least one processor; and
at least one memory device configured to store instructions which, when executed by the at least one processor, cause the system to:
detect that a gaming device and a mobile device have established a communication link,
detect gaming information associated with one or more of the gaming device and a wagering game presented via the gaming device,
select one of a plurality of profiles for the mobile device based on at least a portion of the gaming information, wherein the selected profile includes one or more settings for the mobile device that are configured based on the gaming information, and
use the selected profile for the mobile device during a wagering game session at the gaming device.

16. The system of claim 15, wherein the instructions, when executed by the at least one processor, further cause the system to
modify the profile for the mobile device based on the gaming information.

17. The system of claim 15, wherein the instructions, when executed by the at least one processor, further cause the system to
detect that an additional mobile device is within a proximity to the gaming device, and
modify a profile for one or more of the mobile device and the detected additional mobile device.

18. The system of claim 17, wherein the instructions, when executed by the at least one processor, further cause the system to
establish a communication link between the mobile device and the detected additional mobile device, and
communicate, via the communication link, the gaming information between the mobile device and the at least one additional mobile device.

19. The system of claim 17, wherein the gaming information comprises one or more of wagering game data for a community wagering game, and monetary data to pool money between player accounts associated with the mobile device and the additional mobile device.

20. An apparatus comprising:
at least one input device configured to receive an indication of a wager to play a wagering game;
at least one display device configured to display the wagering game;
at least one processor; and
at least one memory device configured to store instructions which, when executed by the at least one processor, cause the apparatus to
establish a communication link between a mobile device and a gaming device,
detect mobile device information associated with the mobile device,
access a profile associated with one or more of the gaming device and a wagering game presented via the gaming device, wherein the profile specifies one or more settings for one or more of the gaming device and the wagering game, and
modify the profile for the one or more of the gaming device and the wagering game based on the mobile device information.

21. The apparatus of claim 20, wherein the instructions to modify the profile for the one or more of the gaming device and the wagering game include instructions that, when executed by the at least one processor, cause the apparatus to
determine that the one or more settings indicate a preference to prevent interruptions via the mobile device during a wagering game session, and
in response thereto, disable one or more features of the one or more of the wagering game and a wagering game machine via which the wagering game is presented.

22. The apparatus of claim 20, wherein the instructions to modify the profile for the one or more of the gaming device and the wagering game include instructions that, when executed by the at least one processor, cause the apparatus to
detect that one or more additional mobile devices are located within a given distance to one or more of the gaming device and the mobile device,
in response thereto, transmit a portion of content associated with a player account logged in to the gaming device to the mobile device for display via the mobile device, and
modify the one or more settings to prevent the portion of the content from being presented via the gaming device.

23. The apparatus of claim 22, wherein the portion of the content is related to one or more of financial data for the player account, a social communication sent to, or from, the player account, player account history, a gaming history, and responsible gaming information.

24. The apparatus of claim 20, wherein the instructions to modify the profile for the one or more of the gaming device and the wagering game include instructions that, when executed by the at least one processor, cause the apparatus to modify the one or more settings based on at least a portion of gaming history of a player account associated with a wagering game session for the wagering game, wherein the player account is associated with a player to whom the mobile device is assigned.

25. An apparatus comprising:
means for determining that a mobile device and a gaming device are linked;
means for accessing a first profile for a wagering game in response to detecting that the mobile device is linked with the gaming device;
means for reading one or more first settings of the first profile, wherein the one or more first settings indicate information associated with the wagering game; and
means for modifying one or more second settings of a second profile for the mobile device based on the one or more first settings for the wagering game indicated in the first profile.

26. The apparatus of claim 25, wherein the one or more first settings of the first profile relate to at least one presentation mode of the wagering game and wherein the one or more second settings relate to one or more functions of the mobile device associated with the at least one operational mode of the wagering game.

27. The apparatus of claim 26, wherein the at least one operational mode of the wagering game is related to three-dimensional content presentation.
